(19) United States
(12) Patent Application Publication
(10) Pub. No.: US 2025/0126486 A1
(43) Pub. Date: Apr. 17, 2025

(54) Methods and Apparatuses for Satellite Pointing Error Estimation and Compensation

(71) Applicant: ViaSat, Inc., Carlsbad, CA (US)

(72) Inventors: David Irvine, Carlsbad, CA (US); Yuhui Ren, San Diego, CA (US)

(21) Appl. No.: 18/719,521

(22) PCT Filed: Dec. 10, 2022
(86) PCT No.: PCT/US2022/052470

§ 371 Date: Jun. 13, 2024

Related U.S. Application Data
(60) Provisional application No. 63/288,110, filed on Dec. 10, 2021.

(51) Int. Cl. H04W 16/28; H01Q 1/28; H04B 7/185

(52) U.S. Cl. CPC H04W 16/28; H01Q 1/288; H04B 7/18515; H04B 7/18517

(57) ABSTRACT

Methods and apparatuses in one or more embodiments use advantageous techniques for calculating and uploading polynomials to a satellite of a satellite communications system, for use by the satellite in ongoing, dynamic compensation of antenna pointing errors.

### TECHNICAL FIELD

Methods and apparatuses disclosed herein relate to determining and compensating for pointing errors of satellite antennas.

### BACKGROUND

An example antenna system used in transmit beamforming includes a plurality of antenna feeds, with each antenna feed outputting a respective component beam. With the right set of beamforming weights applied to the respective component beams—i.e., relative phases and/or attenuations—the component beams interact in the far field to form a desired set of beams, such as spot beams in a satellite communications system.

Although the beamforming weights applied to the component beams control the beamforming and may inherently account for misalignment of the antenna system, misalignment of the antenna system lowers the overall capacity and efficiency. Consider an example scenario where the satellite communications system is intended to form a set of user spot beams for serving user terminals (UTs) in a satellite service area, with each user spot beam having a user beam footprint that illuminates a predesignated user beam coverage area within the satellite service area.

In the foregoing scenario, the antenna system has a nominal pointing direction, e.g., a nominal boresight alignment with a specific geographic location, that is ideal for formation of the desired set of user spot beams covering the satellite service area. If the antenna is not pointed in this ideal direction, overall capacity and efficiency will be reduced. Deviations from the nominal pointing direction arise for a variety of reasons and include both fixed error sources and time-varying error sources.

Fixed error sources are a function of satellite design and construction tolerances, while variations in satellite pointing error are largely driven by thermal and ephemeris errors. Thermal errors are response to solar heating of satellite structures, primarily the structures constituting the antenna system, including the reflector surface, the frame to which it is mounted, and the booms attaching the reflector to the spacecraft. Change in localized temperatures cause movement of the reflector away from its nominal position, and deviation of its shape from the designed surface.

Satellite ephemeris is a measure of the location of the satellite over time. If a satellite has a known position at time t0 and known orbit parameters, its position can be computed via orbit propagation. Satellites are tracked by measuring satellite ephemeris periodically and propagating the previously estimated orbit until new measurements are made. Ephemeris error reflects how far the position of the satellite is from what is believed to be its position.

Satellites undergo maneuvers for several reasons, including when correcting the spacecraft orbit to compensate for accumulated error due to sun and moon gravitation, and when moving the satellite to avoid space debris or another satellite operating in the same location. Maneuvers are not automatically folded into the satellite ephemeris. Ephemeris-measuring is done based on command and telemetry link measurements, separate from the mechanisms used to decide how and when to use thrusters. The maneuvering process involves designing a thrust event, executing it, then measuring ephemeris after the fact to understand its effect. Maneuvers therefore inject additional error into the ephemeris, with this additional error removed upon making new ephemeris measurements.

One approach that is recognized herein for compensating for antenna pointing error over any given interval of time is to provide the satellite with a polynomial that it evaluates at respective fine increments of time over the given interval, to determine the pointing-error compensation during the given interval. For this scheme to work, the polynomial must account for the pointing-error behavior of the satellite during the given interval. Extending this approach in a simplified view, the satellite may be provided with a set of polynomials, with one for each hour of the day. However, the polynomials held in the satellite should be refreshed on a recurring basis and obtaining the measurements supporting the computation of new polynomials in coordination with accomplishing the refreshes in a coherent and failure-tolerant manner is exceedingly complex.

### SUMMARY

Methods and apparatuses in one or more embodiments use advantageous techniques for calculating and uploading polynomials to a satellite of a satellite communications system, for use by the satellite in ongoing, dynamic compensation of antenna pointing errors. The techniques exploit daily correlations in certain types of pointing error sources and employ an approach to uploading the polynomials that is robust and low in signaling overhead. In the same or one or more other embodiments, methods and apparatuses use advantageous techniques for measuring the antenna pointing errors for computation of pointing-error metrics and corresponding determination of polynomials.

An example embodiment comprises a method of updating a set of polynomials held in a buffer of a satellite. In this context, each polynomial is held in a respective one among a plurality of ordered buffer positions collectively representing a buffer cycle that is an integer multiple of a base twenty-four cycle. The buffer cycle is subdivided into an integer number of sub-intervals, with each buffer position corresponding to a respective one of the sub-intervals and the satellite configured to apply the set of polynomials in sequence over each buffer cycle, for compensating a pointing error of an antenna system onboard the satellite. The method includes computing a set of new polynomials from pointing-error measurements made over a most recently completed measurement interval, which is defined as a contiguous span of sub-intervals equal in length to the buffer cycle and for which coherent pointing-error measurements are available. In relation to the new set of polynomials, the set of polynomials in the buffer of the satellite are considered old polynomials and the method further includes transferring the new polynomials to the satellite for replacement of the old polynomials.

Transferring using a two-stage transfer process that includes a first upload and a subsequent second upload. The first upload is performed in one or more consecutive sub-intervals defining an upload management window. The first upload defines a first transition window that immediately follows the upload management window in linear time and a second transition window that follows the first transition window in linear time. The first upload contains one or more first transitional polynomials for loading into the one or more buffer positions corresponding to the first transition window, one or more second transitional polynomials for loading into the one or more buffer positions corresponding to the second transition window, and new polynomials for loading into the buffer positions corresponding to the sub-intervals between the first and second transition windows, with respect to linear time. The second upload is performed after successful completion of the first upload, with the second upload completing the replacement of new polynomials for all buffer positions.

A related example embodiment comprises a ground node in a ground segment of a satellite communications. The ground node includes interface circuitry and processing circuitry. The processing circuitry is configured to update a set of polynomials held in a buffer of a satellite of the satellite communications system. Each such polynomial is held in a respective one among a plurality of ordered buffer positions collectively representing a buffer cycle that is an integer multiple of a base twenty-four cycle. The buffer cycle is subdivided into an integer number of sub-intervals, with each buffer position corresponding to a respective one of the sub-intervals, with the satellite configured to apply the set of polynomials in sequence over each buffer cycle, for compensating a pointing error of an antenna system onboard the satellite.

To carry out the update of the polynomials buffered in the satellite, the processing circuitry is configured to compute a set of new polynomials from pointing-error measurements made over a most recently completed measurement interval, which is defined as a contiguous span of sub-intervals equal in length to the buffer cycle and for which coherent pointing-error measurements are available.

In relation to the new polynomials computed for the most recently completed measurement interval, the set of polynomials in the buffer of the satellite are considered old polynomials and the processing circuitry is configured to transfer the new polynomials to the satellite for replacement of the old polynomials using a two-stage transfer process that includes a first upload and a subsequent second upload. For carrying out the two-stage transfer, the processing circuitry is configured to perform the first upload in one or more consecutive sub-intervals defining an upload management window. The first upload defines a first transition window that immediately follows the upload management window in linear time and a second transition window that follows the first transition window in linear time. The first upload contains one or more first transitional polynomials for loading into the one or more buffer positions corresponding to the first transition window, one or more second transitional polynomials for loading into the one or more buffer positions corresponding to the second transition window, and new polynomials for loading into the buffer positions corresponding to the sub-intervals that are between the first and second transition windows, with respect to linear time. The processing circuitry is configured to perform the second upload after successful completion of the first upload, with the second upload completing the replacement of new polynomials for all buffer positions.

Another example embodiment comprises a ground node in a ground segment of a satellite communications system that further includes a space segment comprising a satellite. The ground node includes interface circuitry and processing circuitry. The processing circuitry is configured to obtain, via the interface circuitry, measured received powers with respect to Satellite Access Nodes (SANs) in a SAN farm comprising a plurality of geographically distributed SANs. The measured received power for each SAN is determined with respect to an antenna system onboard a satellite of the satellite communications system and is dependent upon an actual pointing direction of the antenna system and a position of the SAN within the SAN farm. The processing circuitry is further configured to determine, for each SAN, a power difference between the measured received power and an expected received power corresponding to a nominal pointing direction of the antenna system, and compute pointing error metrics for the antenna system as a composite sum of the power differences weighted according to the respective positions of the SANs.

A corresponding example embodiment comprises a method of operation in a satellite communications system, with the method including the ground node (a) obtaining measured received powers with respect to SANs in a SAN farm comprising a plurality of geographically distributed SANs, the measured received power for each SAN determined with respect to an antenna system onboard a satellite of the satellite communications system, and being dependent upon an actual pointing direction of the antenna system and a position of the SAN within the SAN farm, (b) determining, for each SAN, a power difference between the measured received power and an expected received power corresponding to a nominal pointing direction of the antenna system, and (c) computing pointing error metrics for the antenna system as a composite sum of the power differences weighted according to the respective positions of the SANs.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of an example buffer of a satellite, used to hold polynomials that are used by the satellite to compensate for antenna pointing error.

FIG. 2 is a state diagram for an example satellite buffer, with respect to an uploading scenario.

FIGS. 3A and 3B is a diagrams of an example satellite buffer and corresponding buffer cycles, in the context of two respective upload scenarios.

FIGS. 4-7 are state diagrams for an example satellite buffer, with respect to additional uploading scenarios.

FIG. 8 is a block diagram of a satellite communications system in an example embodiment.

FIGS. 9 and 10 are block diagrams of antenna systems onboard a satellite in an example embodiment.

FIG. 11 is a block diagram of a Satellite Access Node (SAN) in an example embodiment.

FIG. 12 is a block diagram of interface and processing circuitry implemented in one or more ground nodes in a ground segment of a satellite communications system in an example embodiment.

FIG. 13 is a block diagram of further example details for a ground node in a ground segment of a satellite communications system.

FIGS. 14-16 are flow diagrams of example methods of operation by one or more ground nodes in a satellite communications system.

FIG. 17 is a diagram depicting an example arrangement for nominal alignment of the boresight of a satellite antenna system used for communicatively coupling the involved satellite to SANs in a SAN farm.

FIG. 18 is a diagram depicting a map of expected received power across the SAN farm of FIG. 17, for the nominal alignment of the antenna boresight.

FIG. 19 is a diagram depicting an example boresight misalignment of the boresight in comparison to the nominal alignment depicted in FIG. 17.

FIG. 20 is a diagram depicting a map of example measured received power across the SAN farm of FIG. 17, for the misalignment of the antenna boresight shown in FIG. 19.

FIG. 21 is a diagram depicting an example arrangement where the component beams of a satellite antenna system used for communicatively coupling a satellite with user terminals (UTs) cover a larger geographic area that subsumes the area consumed by a SAN farm, and where there is a nominal boresight location within the coverage area.

FIG. 22 is a diagram depicting, with respect to FIG. 21, an example deactivation of certain component beams of the satellite antenna system, for estimation of the pointing error of the antenna system.

FIG. 23 is a diagram depicting a map of expected received power across the SAN farm of FIG. 21, for the nominal alignment of the antenna boresight.

FIG. 24 is a diagram depicting an example boresight misalignment of the boresight in comparison to the nominal alignment depicted in FIG. 21.

FIGS. 25-27 are diagrams depicting an example realization of a coherent compensation polynomial, for use by a satellite in compensating a corresponding antenna pointing error.

### DETAILED DESCRIPTION

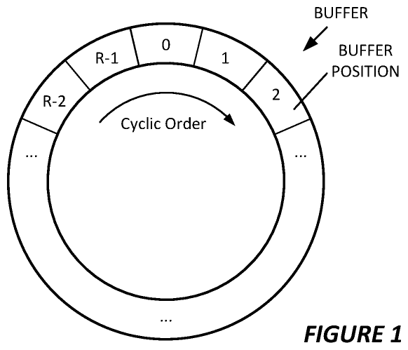

FIG. 1 depicts an example buffer included in circuitry onboard a satellite—not shown in the figure. The buffer comprises a plurality of ordered buffer positions collectively representing a buffer cycle that is an integer multiple of a base twenty-four cycle. The buffer cycle subdivided into an integer number of sub-intervals, with each buffer position corresponding to a respective one of the sub-intervals. With this arrangement, each buffer position represents a particular interval of time that reoccurs each buffer cycle. That is, starting anywhere in the buffer, a complete buffer cycle spans the full set of sub-intervals or put another way, spans the full set of buffer positions.

Each such buffer position or slot, which may be understood as one or more storage elements configured, is to hold respective contents. In particular, polynomials are stored in the buffer. For each sub-interval in the buffer sequence, the satellite uses the polynomial held in the corresponding buffer position to make continuous pointing error compensations throughout the sub-interval, for an antenna system onboard the satellite. The polynomial held in each buffer position may, in fact, be a related pair of polynomials, with one polynomial in the pair used to compute azimuthal corrections for the involved antenna system, and with the other one in the pair used compute elevational corrections for the involved antenna system.

The polynomials are n-th order and represented as a corresponding set of coefficients for the involved variable, which is time. As such, the polynomial held in the buffer for a particular sub-interval can be understood as a set of coefficient values calculated from past measurements of pointing error that are relevant to that sub-interval. The satellite evaluates the polynomial continuously or repeatedly over the sub-interval, such that its pointing-error compensation across the sub-interval follows the error behavior represented by the polynomial.

In one example implementation of the satellite, the satellite reads each buffer position at the beginning of the sub-interval corresponding to the buffer position. The pointing-error compensation applied by the satellite during the sub-interval continues using the polynomial initially read from the buffer position, even if the contents of the buffer position are changed later during the sub-interval. In other words, with this arrangement, changing the contents of a buffer position after the start of the sub-interval that corresponds to the buffer position does not upset the pointing-error compensation being applied by the satellite during the sub-interval. In another example implementation, however, each repeated evaluation of the polynomial by the satellite over the sub-interval reads from the buffer position, meaning that any changes to the buffer contents made during the sub-interval upset or otherwise change the error compensation ongoing for that sub-interval.

Various techniques disclosed herein represent, among other things, advantageous mechanisms for refreshing the polynomials buffered in the satellite, e.g., based on ongoing observation of pointing error, with these techniques offering the advantage of ensuring that the satellite always has a coherent set of polynomials in its buffer, and that the new polynomials used for refreshing the buffer are computed using coherent data. As an overview, the techniques include a two-stage transfer process that makes refreshing the buffered polynomials less burdensome from a systems-operation perspective and more robust or failure tolerant from the perspectives of both the satellite and the ground segment of the involved satellite communications system.

One aspect that, nominally, the polynomials buffered in the satellite at any given time are “compensation” polynomials in the sense that they are computed based on observations of antenna pointing error, for use by the satellite in compensating the pointing error. The two-stage transfer process changes this approach. Consider a case where the set of polynomials held in the satellite are compensation polynomials previously computed and uploaded to the satellite, e.g., using a prior performance of the two-stage transfer. To refresh these “old” polynomials in the satellite buffer, the ground segment computes new compensation polynomials, simply referred to as new polynomials. However, rather than upload the whole set of new polynomials to the satellite, the ground segment first uploads a mix that includes new polynomials and “transitional” polynomials. A transitional polynomial may be applied by the satellite in the same manner as a compensation polynomial, but transitional polynomials are computed to mathematically smooth the transition between a respective pair of polynomials. A related subsequent second upload leaves the satellite buffer filled with the complete set of new polynomials.

In this context, the set of polynomials held in the buffer of the satellite at any given time may be a homogeneous set—i.e., a complete set of compensation polynomials all computed from data collected during the same measurement interval—or may be a heterogenous set—i.e., a mix of compensation polynomials and transitional polynomials, and, in at least some scenarios, where the compensation polynomials are not from the same data set. Here, “not from the same data set” means not computed from measurements of pointing error taken in the same measurement interval. A measurement interval in this sense may be understood as a complete buffer cycle, with the qualifier that the starting position may be anywhere relative to the buffer order, i.e., the measurement cycle may start at a sub-interval corresponding to any given position in the buffer.

With these points in mind, any given set of polynomials has two facets of “coherency.” The first facet is “mathematical” coherency, and the second facet is “data” coherency. A set is mathematically coherent if the set exhibits equal values and equal first derivatives at the boundaries between polynomials, and furthermore exhibits equal value and equal first derivatives at the beginning of the first polynomial in the set and the end of the last polynomial in the set. The “first” and “last” terms here refer to cyclic order in the context of the buffer cycle, with the understanding that “first” could refer to any starting buffer position/sub-interval in the cycle.

Mathematical coherency is important because it prevents vibrations or other disturbances in the antenna pointing mechanisms onboard the satellite that are driven according to the polynomials. Mathematical coherency is ensured by using the property that the sum of two coherent sets of polynomials must also be coherent, and by using the fact that any compensation polynomial comprises the sum of a sequence of coherent error polynomials.

“Data” coherency attains if every polynomial in the set of polynomials is a compensation polynomial computed from pointing-error measurements collected during a same measurement interval, presupposing that the set of polynomials in use by the satellite during that measurement interval had data coherency, or at least were a homogenous set of compensation polynomials, or an initializing set of zero polynomials. Data coherency may be understood as a property possessed by a set of polynomials calculated from pointing-error measurements that are coherent—i.e., all belonging to the same measurement interval and where the set of polynomials played out at the satellite over that measurement interval had data coherency.

According to the disclosed techniques, all sets of polynomials are computed so as to have mathematical coherency. For example, a homogenous set of compensation polynomials has both data coherency and mathematically coherency. A mixed set of compensation polynomials and transitional polynomials, such as uploaded as the first transfer in the two-stage transfer described herein, has mathematical coherency but not data coherency. Of course, the second transfer of the two-stage transfer ensures that the buffer of the satellite has a complete set of new polynomials—i.e., new compensation polynomials-exhibiting both data coherency and mathematical coherency. A set of polynomials having both mathematical and data coherency may be referred to as “fully coherent.”

As explained later herein, successful completion of the second transfer in any given performance of the two-stage transfer leaves the satellite loaded with a set of new polynomials that are fully coherent and thus provides the basis for beginning a next measurement interval.

The satellite operating with polynomials determined during a prior measurement interval exploits the advantageous recognition that certain pointing error sources are highly correlated across succeeding days for the same hours of the day. That is, pointing error observed during a given hour on one day correlates strongly with pointing error observed during the same given hour of the next day, at least for certain sources of pointing error.

As one example, thermally related pointing errors are similar from one day to the next, because solar loading is highly correlated across successive days. For example, the sun angle to the satellite repeats almost exactly every day, which means that every structure on the satellite sees an almost identical solar load profile from one day to the next. Exceptions to the repeating nature of thermal effects include eclipses, which occur once each day during a forty four (44) day interval in the spring and fall, and last up to about seventy (70) minutes each. A satellite entering the Earth's shadow experiences rapid cooling. Conversely, the satellite experiences rapid reheating as it moves from the shadow back into full sunlight.

Ephemeris error also exhibits correlation across successive days. Ephemeris error, expressed as degrees from ideal position, translates almost directly into antenna pointing error toward the ground. Ephemeris errors from one day to the next are related but accumulate day over day. Thus, the ephemeris error on a given day is similar to the error on the next day, absent maneuvers, but gets larger day over day. Ephemeris error become small again—is reset—upon updated ephemeris becoming available.

With these assumptions and the foregoing description of polynomials, the ground segment of an example satellite communications system estimates pointing error of the involved antenna system onboard the satellite for each sub-interval of a measurement interval that is equal in length to the buffer cycle of the satellite. While that estimation occurs, the satellite applies a currently buffered set of polynomials. At the end of the measurement interval, the satellite cycles back to the first polynomial in its currently buffered set—i.e., it restarts its use of the set of polynomials held in its buffer. Meanwhile, the ground segment uses the pointing-error measurements determined during the measurement interval to compute a new set of compensation polynomials.

After the ground segment has computed the new polynomials, it uploads some of them in a first upload of a two-stage process, and then finishes uploading them in a second upload. Completion of the second upload leaves the buffer of the satellite filled with the new polynomials—i.e., a new set of compensation polynomials that are data coherent and mathematically coherent, which allows the ground segment to begin its next measurement interval for computing a next new set of polynomials. During the interim between completion of the first upload and the second upload, the satellite operates with a mixed set of polynomials that are mathematically coherent but not data coherent. Transitional polynomials within the mixed set ensure mathematical coherency at the transition points created in the buffer of the satellite by the first upload. As such, the ground segment does not make pointing-error measurements or does not use any such measurements for purposes of computing the next new set of polynomials.

However, the two uploads and the interim use of the mixed set makes the two-stage transfer process flexible in terms of when the uploads can occur relative to the buffer cycle and when the second upload occurs relative to the first upload. This flexibility makes the process tolerant of upload failures and allows each upload to be attempted multiple times or distributed over more than one consecutive sub-interval, thus giving the ground segment significant flexibility in dealing with uplink failures or the need to send higher-priority operational control signaling. Further, to the extent that the first upload is delayed from a planned upload time, the ground segment can continue sliding the measurement interval used for computation of the new polynomials, such that the new polynomials transfer to the satellite via the two-step process reflect the latest available measurement data.

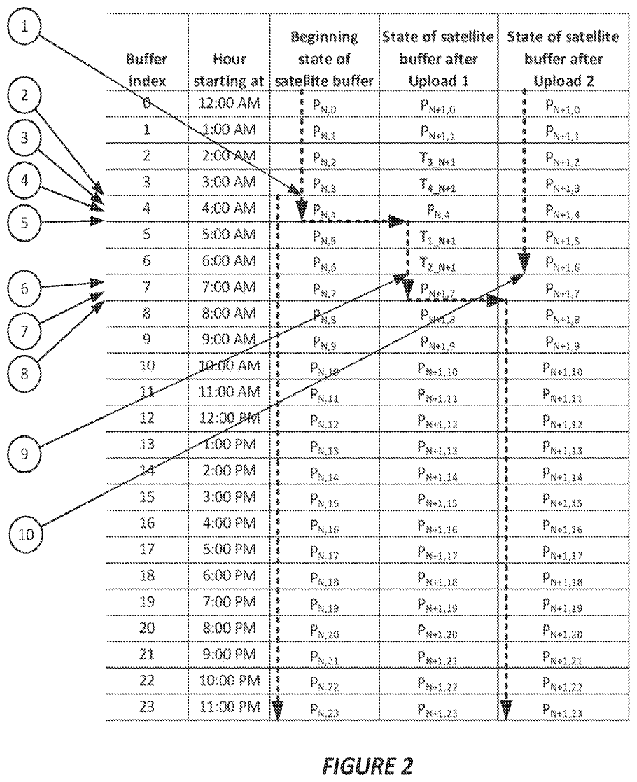

FIG. 2 is a buffer state diagram illustrating an example buffer arrangement and the buffer states resulting from an example performance of the two-stage transfer process. In this context, the buffer cycle is twenty-four-hours long and the sub-intervals are respective hours of the day. In buffer order, the first buffer position is referenced to the 12:00 AM hour and the last buffer position is referenced to the 11:00 PM hour.

Item 1 denotes the end of a most recent measurement interval N, coinciding with the end of the associated update interval N at the end of 3:00 AM hour on a Tuesday, and the corresponding beginning of the next update interval N+1 starting on the 4:00 AM hour. Item 2 shows the buffer pointer position in the satellite at 4:00 AM Tuesday, i.e., the pointer position after the measurement interval N completes. Item 3 shows initiation of the first upload and Item 4 shows completion of the first upload. In this example, the ground system was able to compute the new polynomials from the data collected during the measurement interval N, initiate the first upload, and complete the first upload, all during the 4:00 AM hour—i.e., all within the sub-interval represented by “Buffer Index 4.”

With the first upload completed within the 4:00 AM hour, it is activated at the next sub-interval in cyclic order, i.e., the 5:00 AM hour. Here, “activated” means use begins and use may also be referred to “playout.” In other words, sometime during the 4:00 AM hour, the first upload to the satellite completes, meaning that all buffer positions represented in the first upload are updated according to the respective contents conveyed in the first upload.

Item 6 shows initiation of the second upload during the 7:00 AM hour, Item 7 shows completion of the second upload during the same hour and Item 8 shows activation of the second upload at the start of the 8:00 AM hour. Completion of the second upload leaves the satellite buffer filled with a complete set of polynomials having both data coherency and mathematical coherency. Thus, Item 9 shows the beginning of the next measurement interval N+1 beginning in the 7:00 AM hour, coincident with activation by the satellite of the first new polynomial following the first transition window. Item 10 shows the end of the measurement interval N+1 and coincident end of the update interval N+1, and the beginning of the update interval N+2.

Note that in FIG. 2, P_{N,0}, P_{N,1}, and so on denote the set of polynomials held in the buffer of the satellite with respect to the measurement interval N—i.e., played out (used) by the satellite during the measurement interval N. This set of polynomials should be understood as a set of compensation polynomials having both data and mathematical coherency—i.e., they were previously computed by the ground segment from data collected for the measurement interval N−1. They may be referred to as the old polynomials with respect to the update represented in the diagram.

P_{N+1,0}, P_{N+1,1} and so on are new compensation polynomials in the new set computed using the measurement data collected over the measurement interval N. This new set of compensation polynomials may be referred simply as the new polynomials. Rather than uploading the whole set of new polynomials at once, the first upload contains a mix of new polynomials and transitional polynomials. The first upload may contain polynomials only for those buffer positions whose contents are to be changed by the first upload, or it may contain as many polynomials as there are buffer positions. Indeed, any upload set of polynomials may always contain as many polynomials as there are buffer positions in the satellite buffer, to simplify the writing logic. If an upload is intended to change a given buffer position, the upload includes new contents for that given buffer position. Conversely, for a given buffer position that is to be unchanged by the upload, the upload may either omit contents for that buffer position, or it may include a copy of the current contents of that buffer position, which are always known to the ground segment.

T_{1_N+1} and T_{2_N+1} denote first transitional polynomials that provide a smooth transition from old polynomial P_{N,4} in use for the 3:00 AM hour and the new polynomial P_{N+1,7} that will be in use after the first transition window represented by the first transitional polynomials. While the use of two transitional polynomials to define a transition window has practical advantages in terms of the mathematical smoothing, there are embodiments or instances in which only one or more than two are used.

T_{3_N+1} and T_{4_N+1} denote second transitional polynomials that provide a smooth transition from the new polynomial P_{N+1,1} and the old polynomial P_{N,4} that will be in use after the second transition window represented by the second transitional polynomials. More particularly, the second transitional polynomials will not be used at all-they will be overwritten with the corresponding new polynomials—as long as the second upload completes before the satellite cycles back to them. As such, the second transition window can be understood as a contingency provision that leaves the satellite with a mathematically coherent set of polynomials to use in the interim between completion of the first upload and completion of the second upload.

To appreciate this scheme more broadly, the approach can be understood as having a measurement interval of the same length as the buffer but having an overall update interval that subsumes the measurement interval and includes some number of additional subintervals associated with carrying out the two-stage transfer. The number of additional sub-intervals may be defined nominally. As noted, however, upload failures, unavailability of the upload link, limitations on ground-segment compute resources, etc., all may delay or extend the first upload and/or the second upload. In this regard, an upload may happen partially in each of two or more sub-intervals.

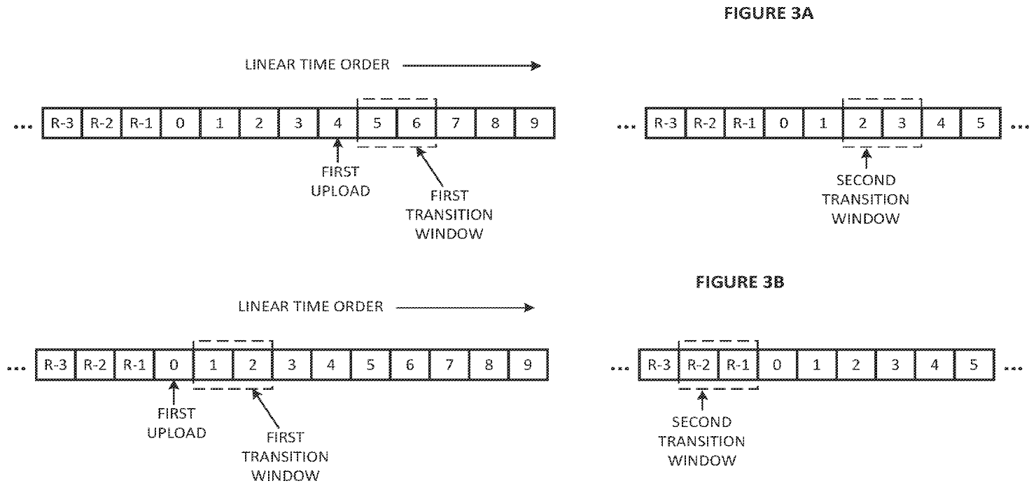

In any case, FIG. 3A illustrates the satellite buffer in the context of the first and second uploads at issue in FIG. 2. The first upload is completed during the sub-interval corresponding to the buffer index 4 and it places the first transitional polynomials T_{1_N+1} and T_{2_N+1} in the two buffer positions immediately following the buffer position for which the first upload completed.

The second transition window follows the first transition window in linear time, although, due to the cyclic nature of the buffer, the buffer positions occupied by the second transitional polynomial(s) that define the second transition window may be “before” or “after” those of the first transition window, where “before” and “after” here refer to buffer index order. See FIG. 3B for another example of how the transition windows are positioned in terms of buffer index, as a function of where in the buffer cycle the first upload completes.

In dependence on whether the satellite is tolerant of the corresponding buffer contents being changed while a sub-interval is underway, the first upload may leave or change the old polynomial in the buffer position corresponding to the sub-interval in which the first upload is completed.

As a further variation, with the allowance for the first upload to be delayed or to spread over more than one consecutive sub-interval, the ground segment may be regarded as performing the first upload during an “upload management window” that spans and aligns with one or more of the sub-intervals defined by the buffer. To the extent that the upload management window is more than one sub-interval long, the second transition window in one or more embodiments may be defined to overlap the first sub-interval in the upload management window.

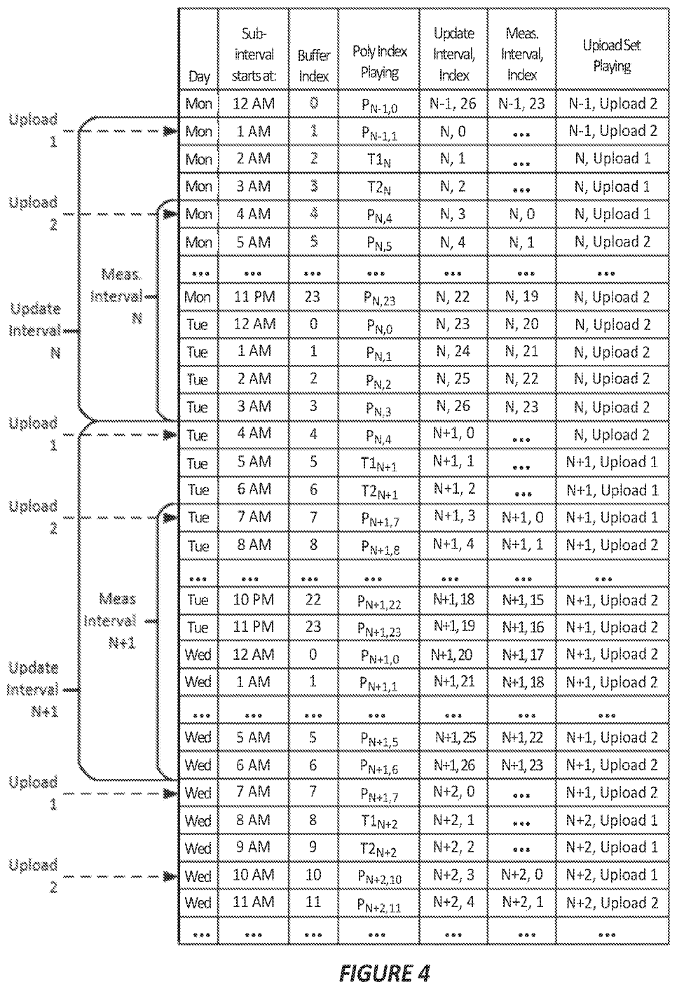

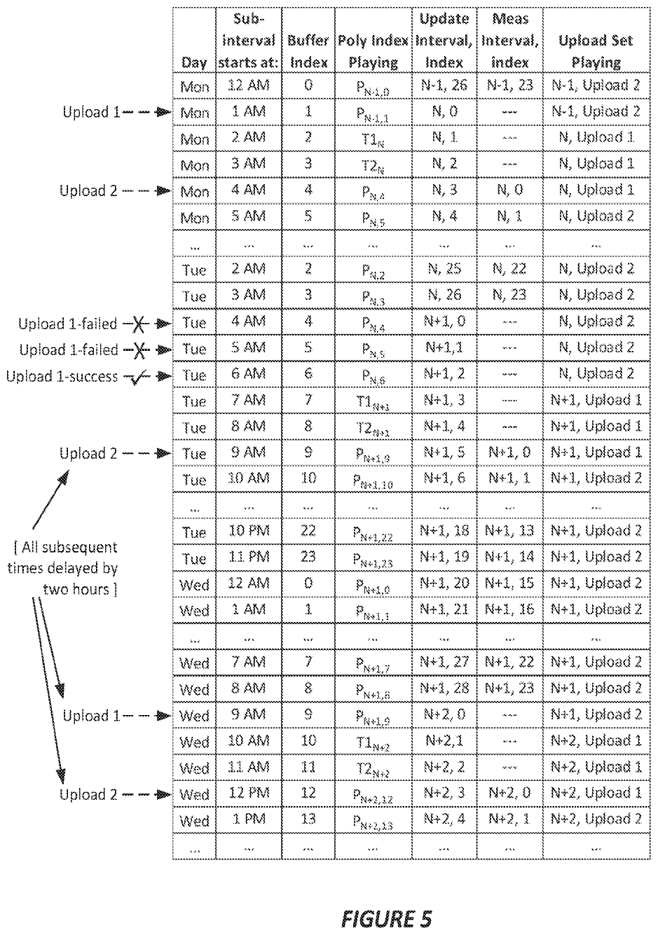

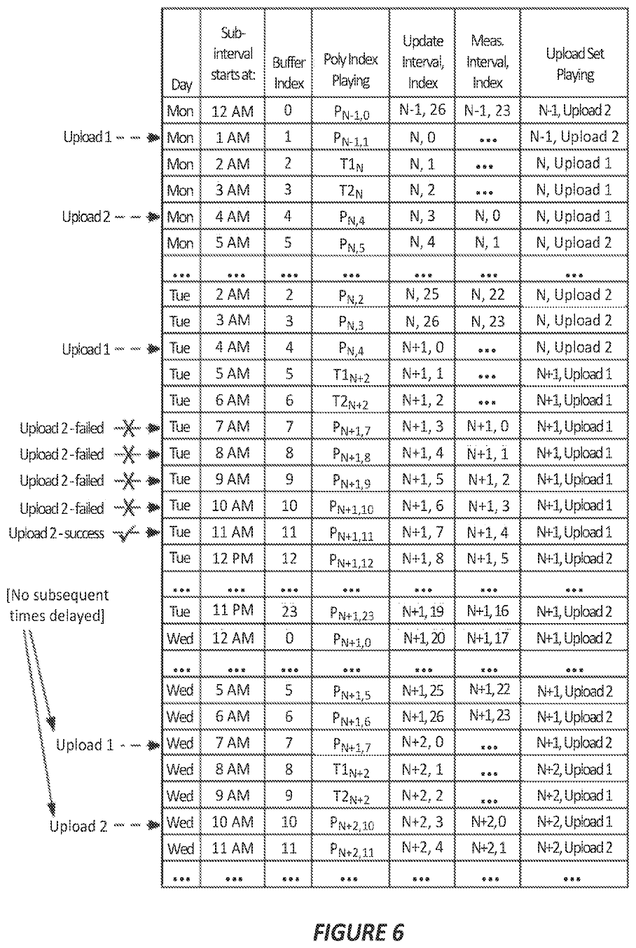

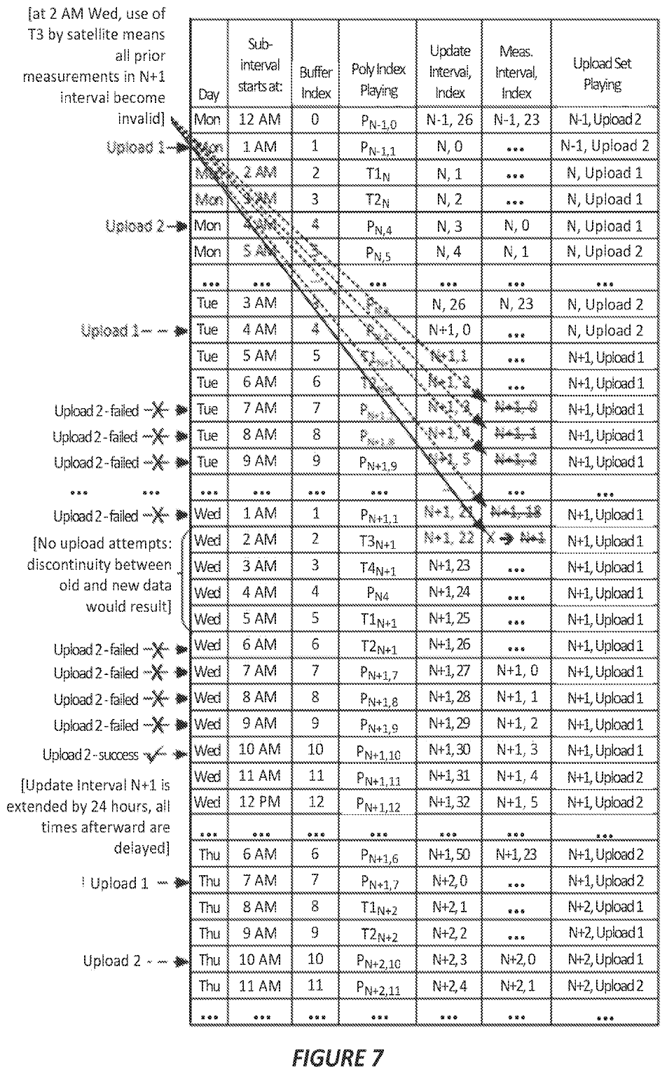

FIG. 4 is a companion to FIG. 2 and illustrates the same example performance of two-stage uploads over successive update intervals for a “sunny day” scenario. This scenario may be understood as a nominal or targeted timing scenario used in at least one embodiment. The example of FIGS. 2 and 4 assumes that the buffer cycle is twenty-four hours and that the sub-intervals defined by the buffer are respective hours of the day. FIG. 5 illustrates an example of a late or delayed first upload. FIGS. 6 and 7 illustrate additional examples of a late or delayed second upload.

With the upload scenarios depicted in FIGS. 2 and 4-7 standing as non-limiting examples, an example method updates a set of polynomials held in a buffer of a satellite. Each polynomial is held in a respective one among a plurality of ordered buffer positions collectively representing a buffer cycle that is an integer multiple of a base twenty-four cycle. The buffer cycle is subdivided into an integer number of sub-intervals, with each buffer position corresponding to a respective one of the sub-intervals and the satellite configured to apply the set of polynomials in sequence over each buffer cycle, for compensating a pointing error of an antenna system onboard the satellite.

Against that framework, the method, which may be performed by a single ground node or jointly by two or more ground nodes of a satellite communications system, includes: (a) computing a set of new polynomials from pointing-error measurements made over a most recently completed measurement interval, which is defined as a contiguous span of sub-intervals equal in length to the buffer cycle and for which coherent pointing-error measurements are available, and wherein in relation the set of polynomials in the buffer of the satellite are considered old polynomials; and (b) transferring the new polynomials to the satellite for replacement of the old polynomials using a two-stage transfer process that includes a first upload and a subsequent second upload.

The two-stage transfer process includes: (i) performing the first upload in one or more consecutive sub-intervals defining an upload management window, the first upload defining a first transition window that immediately follows the upload management window in linear time and a second transition window that follows the first transition window in linear time. The first upload contains one or more first transitional polynomials for loading into the one or more buffer positions corresponding to the first transition window, one or more second transitional polynomials for loading into the one or more buffer positions corresponding to the second transition window, and new polynomials for loading into the buffer positions corresponding to the sub-intervals that are between the first and second transition windows, with respect to linear time; and (ii) performing the second upload after successful completion of the first upload. The second upload completes the replacement of new polynomials for all buffer positions, leaving the buffer of the satellite filled with a fully coherent set of polynomials for use by the satellite during a next measurement interval, during which the ground segments makes pointing-error measurements.

While the second transition window always follows the first transition window in linear time, its transitional polynomials may be located in the satellite buffer at index positions preceding the index positions of the transitional polynomials of the first transition window, in dependence on the buffer index in play when the first upload occurs. See FIGS. 3A and 3B for an example of the transition windows and the following and preceding relationship therebetween, with respect to buffer index position.

With respect to each buffer position, the satellite according to one embodiment reads the contents of the buffer position at the beginning of the corresponding sub-interval, such that changes made to the contents of the buffer position are not read until the next read of the buffer position in the next repetition of the buffer cycle. Correspondingly, the one or more first transitional polynomials are calculated to smooth a transition from use by the satellite of the polynomial read by the satellite at the beginning of the last sub-interval contained in the upload management window to use by the satellite of the polynomial that will be read by the satellite at the beginning of the first sub-interval following the first transition window. Similarly, the one or more second transitional polynomials are calculated to smooth a transition from use by the satellite of the polynomial that will be read by the satellite at the beginning of the last sub-interval before the second transition window to use by the satellite of the polynomial that will be read by the satellite at the beginning of the first sub-interval following the second transition window.

With respect to each buffer position, the satellite according to another embodiment reads the contents of the buffer position repeatedly during the corresponding sub-interval. Correspondingly, the one or more first transitional polynomials are calculated to smooth the transition from the polynomial that is in use in the sub-interval immediately preceding the beginning of the first transition window, to the polynomial that is in use in the sub-interval immediately following the end of the first transition window. Similarly, the one or more second polynomials are calculated to smooth the transition from the polynomial that is in use in the sub-interval immediately preceding the beginning of the second transition window, to the polynomial that is in use in the sub-interval immediately succeeding the end of the second transition window.

The set of old polynomials and the set of new polynomials are respective coherent sets, and the method in one or more embodiments provides coherency in each set by computing each polynomial in the set using partially overlapping measurement times and by smoothing a last one of the polynomials in the set for wraparound transitioning into a first one of the polynomials in the set, for cyclic application of the set by the satellite.

The method in one or more embodiments includes computing the set of new polynomials in a three-step process. The three-step process includes: (i) computing temporary overlapping error polynomials for each sub-interval of the most recently completed measurement interval, where the pointing-error measurements used for determining each overlapping error polynomial extends into the preceding and succeeding sub-intervals within the most recently completed measurement interval; (ii) computing a coherent set of error polynomials for the most recently completed measurement interval from the pointing-error measurements, based on the temporary overlapping polynomials and corresponding boundary values demarking the sub-interval boundaries, to ensure coherency of the error polynomials; and (iii) subtracting the coherent set of error polynomials from the old polynomials to yield the set of new polynomials.

Performing the first and second uploads comprises, for example, transmitting respective first and second signaling on an uplink control channel used to communicate control signaling from a ground segment to the satellite.

In one or more embodiments, the pointing error is an error of a steerable antenna reflector of the antenna system. Thus, each of the old and new polynomials is computed for derivation of azimuthal and elevational steering adjustments of the steerable antenna reflector during the corresponding sub-interval. That is, each old or new polynomial may comprise a respective pair of polynomials, one used for azimuthal adjustments, and one used for elevational adjustments during the corresponding sub-interval.

In one example, the antenna system at issue serves user terminals of a satellite communications system that includes the satellite. In another example, the antenna system serves a SAN farm of a satellite communications system that includes the satellite. Of course, the method may be performed with respect to each of two or more antenna system onboard the satellite.

Regarding the pointing-error measurements used to form any given set of polynomials for use by the satellite in pointing-error compensation, one or more embodiments disclosed herein involve making pointing-error measurements on a relatively fine time basis, e.g., once per minute, during any given measurement interval, and then encoding the measured errors as polynomials and uploading them to the satellite using the advantageous two-step uploading process described above. Polynomial encoding of the estimated pointing error is possible because the pointing error versus time tends to be smooth, and because the entire time series is known ahead of time.

The encoding in one or more embodiments encompasses two variables for the involved antenna: an azimuthal (Az) variable, and an Elevational (El) variable. The encoding comprises, for example, building one higher-order, (e.g., sixth-order, polynomial for each variable for each hour in the twenty-four-hour interval, resulting in 24×2 set of compensation polynomials. The polynomials are then uploaded to the satellite using an advantageous two-step uploading process. As explained, the satellite evaluates each polynomial buffered in it on a continuous basis during the sub-interval for which that compensation polynomial applies and adjusts antenna pointing correspondingly.

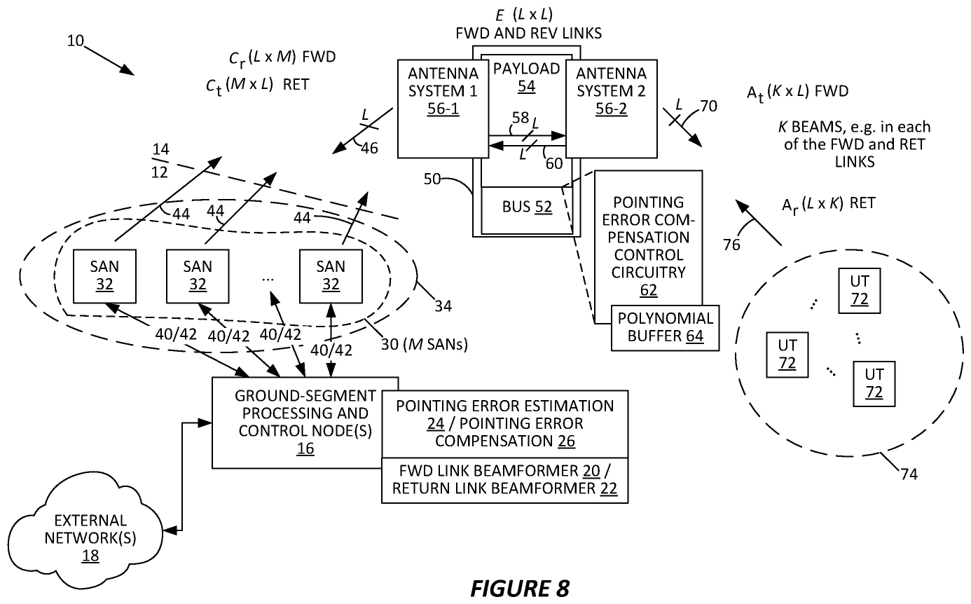

FIG. 8 illustrates a satellite communications system (SCS) 10 that includes a ground segment 12 and a space segment 14. The space segment 14 includes one or more satellites, with at least one satellite operating as described above with respect to buffering and applying compensation polynomials, and with the ground segment 12 implementing the advantageous update process and the satellite operating as previously described to facilitate that process.

The ground segment 12 includes one or more ground-segment processing and control nodes 16, which may be referred to simply as ground nodes 16. The one or more ground nodes 16 interface with one or more external networks 18, such as the Internet, for communicatively coupling user terminals (UTs) served by the SCS 10 with the one or more external networks 18. In the illustrated example, the one or more ground nodes 16 include forward-link beamforming circuitry 20 and return-link beamforming circuitry 22. Forward-link refers to transmissions by the SCS 10 towards the UTs, while reverse-link or return-link refers to transmissions received by the SCS 10 from the UTs.

For implementation of the advantageous update process described above, the ground node(s) 16 include pointing-error estimation circuitry 24 and pointing-error compensation circuitry 26. The circuitry 24 and 26 may or may not be implemented in the same physical node, and, in general, the circuitry 24 may be implemented in a single node or distributed across two or more nodes, and the same holds for the circuitry 26. Further, the ground node(s) 16 which implement the circuitry 24 and 26 may or may not interface with the one or more external networks 18 and may or may not interface with Satellite Access Nodes (SANs) 32 of the ground segment 12, which operate as a SAN farm 30.

The SAN farm 30 includes a number M of SANs 32 actively participating in the forward-link and return-link beamforming. The number M may be large, e.g., in the hundreds or more. The SANs 32 are geographically distributed over a SAN farm area 34. The SANs 32 may also be referred to as terrestrial gateway stations, denoting their role in providing feeder-link connectivity between the ground segment 12 and the space segment 14.

Each SAN 32 receives a respective forward-link SAN signal 40 generated by the ground node(s) 16 and carrying forward user traffic. Further, each SAN 32 transmits a return-link SAN signal 42, which carries return user traffic. Each SAN 32 transmits a respective forward uplink signal 44 for satellite reception, based on the forward-link SAN signal 40 it receives. Each SAN 32 also receives a respective return downlink signal 46 from the satellite 50 being used in the beamforming, with the return-link SAN signal 42 output by the SAN 32 conveying return user traffic contained in the received return downlink signal 46.

The satellite 50 includes a bus 52 and a payload 54, along with a first antenna system 56-1 that communicatively couples the satellite 50 with the respective SANs 32 and a second antenna system 56-2 that communicatively couples the satellite 50 with the UTs. The satellite 50 includes a plurality of forward-link transponders 58, a plurality of return-link transponders 60, and pointing-error compensation control circuitry 62.

Each forward-link transponder 58 comprises, for example, a bent-pipe or non-processed signal path through the satellite 50 that provides signal filtering, frequency translation, and amplification, for example, but does not perform signal demodulation and re-modulation. The input or receive side of each forward-link transponder 58 is coupled to one among a plurality of receive antenna feeds of the first antenna system 56-1 and the output or transmit side of each forward-link transponder 58 is coupled to one among a plurality of transmit antenna feeds of the second antenna system 56-2. As such, the forward-link transponders 58 act as signal relay paths going from the receive antenna feeds of the first antenna system 56-1 to the transmit antenna feeds of the second antenna system 56-2, with the second antenna system 56-2 transmitting forward downlink signals 70 for UTs 72.

The UTs 72 may be distributed in essentially any manner within an overall satellite service area 74, e.g., the continental United States. The UTs 72 may be fixed terminals or mobile terminals or a mix thereof, and the satellite service area 74 may be subdivided into user-beam coverage areas. For example, the forward link signals 70 may be beam-weighted such that they superimpose in the far field to form forward user beams, with each forward user beam having a corresponding forward user beam footprint that illuminates a predesignated forward user beam coverage area comprising a region within the satellite service area 74. The same or different subdivisions of the satellite service area 74 may be used in the return-link context, meaning that the SCS 10 may use return user beams having return user beam footprints/coverage areas that are the same as or different than used in the forward link.

Each return-link transponder 60 comprises, for example, a bent-pipe or non-processed signal path through the satellite 50 that provides signal filtering, frequency translation, and amplification, for example, but does not perform signal demodulation and re-modulation. The input or receive side of each return-link transponder 60 is coupled to one among a plurality of receive antenna feeds of the second antenna system 56-2 and the output or transmit side of each return-link transponder 60 is coupled to one among a plurality of transmit antenna feeds of the first antenna system 56-1. As such, the return-link transponders 60 act as signal relay paths going from the receive antenna feeds of the second antenna system 56-2 to the transmit antenna feeds of the first antenna system 56-1, with the second antenna system 56-2 receiving return uplink signals 76 from the UTs 72.

Beamforming in the example context of FIG. 8 is of a type referred to as end-to-end beamforming. While numerous exemplary details for implementation of end-to-end beamforming appear in various patents, such as U.S. Pat. Nos. 10,128,939 B2, 10,992,373 B2, and 11,095,363 B2, the immediately following description provides a working explanation.

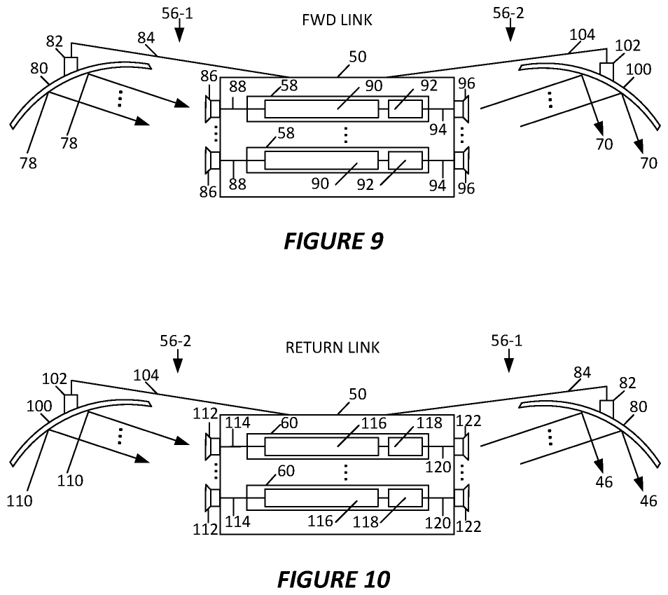

With reference to FIG. 9, in an example embodiment, the first antenna system 56-1 comprises a reflector 80 that connects via a reflector mount 82 to a supporting member 84 that in turn couples to the body of the satellite 50. The reflector mount 82 and/or supporting member 84 are controllable in one or more embodiments, to adjust the azimuthal and/or elevational angles of the reflector 80, for compensation of antenna pointing error affecting the first antenna system 56-1.

With respect to forward-link operations, the reflector 80 receives signals 78 that are superpositions of the plurality of forward uplink signals 44 transmitted by SANs 32 in the SAN farm 30. Because the SANs 32 are geographically separated and each one among a plurality of receive antenna feeds 86 of the first antenna system 56-1 receives reflected signals from a corresponding region of the reflector 80, each forward-link transponder 58 receives a unique superposition of the forward uplink signals 44 via a respective one of the receive antenna feeds 86. These unique signal superpositions may be referred to as composite forward uplink signals 88, with the understanding that each forward-link transponder 58 receives a different composite forward uplink signal 88.

Each forward-link transponder 58 acts as a forward-link relay path and in the example embodiment includes signal path circuitry 90, such as one or more filters and low-noise amplifiers (LNAs). In at least one example embodiment, the signal path circuitry 90 includes a frequency converter, for translation from an uplink signal frequency to a downlink signal frequency. Such an arrangement is used, for example, where the feeder links are in one radiofrequency (RF) band and the user links are in another RF band. The output from the signal path circuitry 90 feeds into a power amplifier (PA) 92, which provides an amplified output signal 94 corresponding to the composite forward uplink signal 88 input to the signal path circuitry 90. The amplified output signal 94 is radiated via a transmit antenna feed 96 onto a reflector 100 of the second antenna system 56-2, which reflects it as a respective one of the forward downlink signals 70 discussed earlier.

Each forward downlink signal 70 corresponds to a respective one of the composite forward uplink signals 78, meaning that each forward downlink signal 70 is a unique superposition of the forward uplink signals 44 transmitted by the SAN farm 30. Consequently, by applying the correctly calculated forward beam weight to each forward uplink signal 44, the forward downlink signals 70 may be weighted such that they superpose in the far field to form the desired set of forward user beams covering the satellite service area 74. Note that each transmit antenna feed 96 may radiate the signal(s) transmitted by it as a respective component beam, such that the far-field interaction of these component beams yields the desired set of forward user beams.

The forward beam weights are calculated based on estimation of the end-to-end channels going between each SAN 32 and a “representative” UT 72 located in each of the desired forward user beam coverage areas. For example, the representative UT 72 for each predefined user beam coverage area is located at or near the geographic center of the coverage area, such that the beamforming solution comprises a set of forward beamforming weights that, when applied to the set of forward uplink signals 44 transmitted by the SAN farm 30, ultimately result in a set of forward downlink signals 70 that superpose to form the desired set of forward user beams.

Similarly, for end-to-end beamforming in the return direction, FIG. 10 provides example details. As detailed above, the second antenna system 56-2 comprises a reflector 100 that connects via a reflector mount 102 to a supporting member 104 that in turn couples to the body of the satellite 50. The reflector mount 102 and/or supporting member 104 are controllable in one or more embodiments, to adjust the azimuthal and/or elevational angles of the reflector 100, for compensation of antenna pointing error affecting the second antenna system 56-2.

The reflector 100 receives signals 110 that are superpositions of the plurality of return uplink signals transmitted by UTs 72 operating in the satellite service area 74. With each receive antenna feed 112 of the second antenna system 56-2 receiving reflected signals from a corresponding region of the reflector 100, each return-link transponder 60 receives a unique superposition of the return uplink signals 76. These unique signal superpositions may be referred to as composite return uplink signals 114, with the understanding that each return-link transponder 60 receives a different composite return uplink signal 114 via a respective one among the plurality of receive antenna feeds 112 of the second antenna system 56-2.

Each return-link transponder 60 in the example embodiment includes signal path circuitry 116, such as one or more filters and low-noise amplifiers (LNAs). In at least one example embodiment, the signal path circuitry 116 includes a frequency converter, for translation from an uplink signal frequency to a downlink signal frequency. Such an arrangement is used, for example, where the feeder links are in one radiofrequency (RF) band and the user links are in another RF band. The output from the signal path circuitry 116 feeds into a power amplifier (PA) 118, which provides an amplified output signal 120 corresponding to the composite return uplink signal 114 input to the signal path circuitry 116. The amplified output signal 120 is radiated via a corresponding transmit antenna feed 122 of the second antenna system 56-2 onto the reflector 80 of the first antenna system 56-1, which reflects it as a respective one of the return downlink signals 46 discussed earlier. The signal(s) transmitted by each one of the transmit antenna feeds 122 may be radiated as a respective component beam.

Each return downlink signal 46 corresponds to a respective one of the composite return uplink signals 114, meaning that each return downlink signal 46 itself is a unique superposition of the return uplink signals 76 transmitted by the UTs 72 operating in the satellite service area 74. These return downlink signals 46 superpose in the far field, such that each SAN 32 receives a different superposition of the return downlink signals 46, with each return-link SAN signal 42 thus conveying a unique superposition of the return downlink signals 46. The unique superposition of return downlink signals 46 received at each SAN 32 may be referred to as a composite return downlink signal. By applying the correctly calculated return beam weights to these composite return downlink signals, the ground segment 12 effectively forms corresponding return user beams in the digital processing domain, with each return user beam having a corresponding return user beam coverage area. The return user beam coverage areas may or may not be the same as the forward user beam coverage areas and the return beam weights are calculated based on estimation of the end-to-end channels going between a representative UT 72 located in each of the desired return user beam coverage areas and each SAN.

Radiation matrices based on estimation of the end-to-end channels are used to calculate the beamforming weights needed to form the desired sets of forward and return user beams. In FIG. 8, Cᵣ is an L×M forward uplink radiation matrix, where L is the number of forward-link transponders 58 used for the forward end-to-end beamforming and M is the number of SANs 32 used for the forward end-to-end beamforming. The values in Cᵣ model the signal paths from each SAN 32 to each receive antenna feed 86 of the first antenna system 56-1. The matrix E is an L×L radiation matrix modeling the amplitude and phase of the transponder paths through the satellite 50.

If the forward-link transponders 58 and the return-link transponders 60 are one and the same—i.e., one set of transponders supports both the forward and return directions—then the same E matrix may be used in both forward and return beamforming. Note, too, the same antenna feeds onboard the satellite 50 may be used for transmission and reception. As such, in at least one embodiment, the set of receive antenna feeds 86 of the first antenna system 56-1 as shown in FIG. 9 is also used as the set of transmit antenna feeds 122 shown in FIG. 10. Likewise, the set of transmit antenna feeds 96 shown in FIG. 9 for the second antenna system 56-2 also may be used as the set of receive antenna feeds 112 shown in FIG. 10.

The matrix Aₜ is a K×L radiation matrix modeling the signal paths from the respective transmit antenna feeds 96 of the second antenna system 56-2 to respective representative UTs 72 in K forward user beam coverage areas. Similarly, in the return direction, the matrix Aᵣ is an L×K radiation matrix modeling the signal paths from the representative UT 72 for each of the K forward user beams to each of the respective receive antenna feeds 112 of the second antenna system 56-2. Further in the return direction, the matrix Cₜ is a M×L radiation matrix modeling the signal paths from each transmit antenna feed 122 of the first antenna system 56-1 to each one of the M SANs 32.

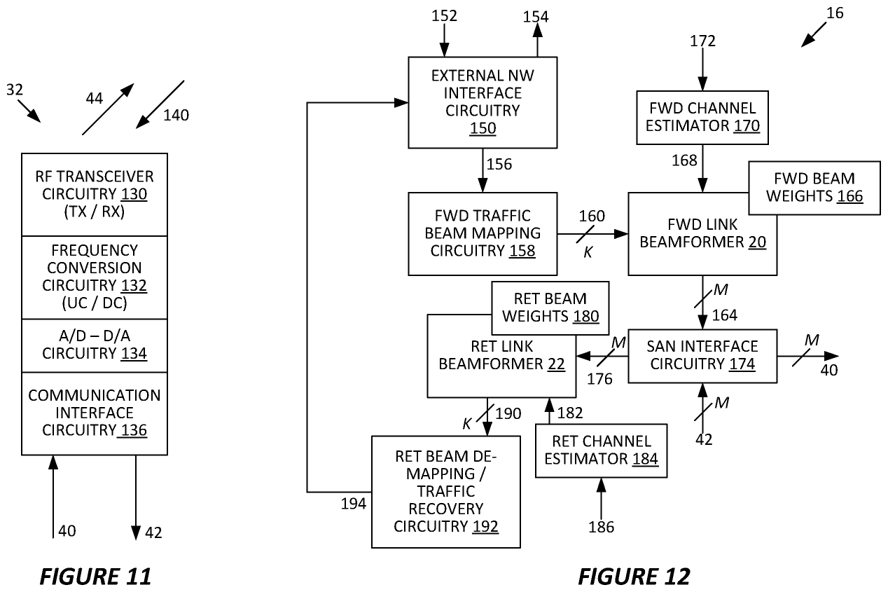

Further example details for the SCS 10 appear in FIGS. 11 and 12, with FIG. 11 depicting an example implementation for each SAN 32. According to the illustrated example, Each SAN 32 includes RF transceiver circuitry 130, which is used by the SAN 32 to transmit its corresponding beam-weighted forward uplink signal 44 and is further used to receive the composite return downlink signal described above and shown here as signal 140.

Frequency conversion circuitry 132 is configured to provide conversion between the RF band(s) used on the feeder link and baseband, while analog-to-digital (A/D) and digital-to-analog (D/A) circuitry 134 converts between the digital and analog domains. For example, the forward-link and return-link SAN signals 40 and 42 are digital-domain signal, with communication interface circuitry 136 communicatively coupling the SAN 32 with the one or more ground nodes 16 responsible for generating or processing the forward-link and return-link SAN signals 40 and 42.

FIG. 12 depicts circuitry and corresponding functionality implemented in one or more ground nodes 16. External network (NW) interface circuitry 150 communicatively couples the SCS 10 to one or more external networks 18, for receiving incoming streams of user traffic 152 destined for targeted ones among the UTs 72 operating in the satellite service area 74, and for transmitting outgoing streams of user traffic received from the UTs 72.

The interface circuitry 150 outputs forward user data streams 156 to forward traffic beam mapping circuitry 158, which schedules user-traffic transmissions in the forward direction and maps the user traffic to respective ones among the K forward user beams, in dependence on which ones among the K forward user beams serve the UTs 72 targeted by the forward user data streams 156. This process results in K forward beam signals 160 being output to the forward-link beamforming circuitry 20, which uses forward beam weights 166 to generate M SAN-specific signals 164 for the M SANs 32 participating in the forward-link beamforming. Forward channel estimation circuitry 170 generates the forward beam weights 166 based on the forward end-to-end channel estimates 168, i.e., for computation of the forward radiation matrices shown in FIG. 8. The M SAN-specific signals 164 are output from SAN interface circuitry 174 as the aforementioned forward-link SAN signals 40. The channel estimates 168 are based on, for example, Channel State Information (CSI) 172 returned from at least one representative UT 72 in each of the K forward user beam coverage areas, with the CSI determined with respect to each one of the M SANs 32, based on each SAN 32 transmitting a unique reference signal.

In the return direction, the SAN interface circuitry 174 receives the return-link SAN signals 42 from the M SANs 32, and outputs a set of M return-link signals 176, which can be understood as digital-domain representations of the composite return downlink signals 140. The return link beamforming circuitry 22 applies return beamforming weights 180 to form K return beam signals 190 in the digital domain. This process can be understood as producing a return beam signal 190 for each of the K return user beam coverage areas, in which the signal-to-noise ratio (SNR) of return uplink signals 76 from UTs 72 in the return user beam coverage area is enhanced, while the return uplink signals 76 from UTs 72 outside of the return user beam coverage area are suppressed. The return beam weights are computed based on channel estimates 182 of the end-to-end return channels. The return channel estimates may be computed by return channel estimation circuitry 184 using CSI 186 generated based on the ground segment 12 receiving a reference signal from each of one or more representative UTs 72 in each return user beam coverage area.

The return beam signals 190 are output to return beam de-mapping and traffic recovery circuitry 192. Such circuitry recovers user data streams 194 and outputs them to the external network interface circuitry 150, for output to the involved external network(s) 18 as outgoing user traffic 154.

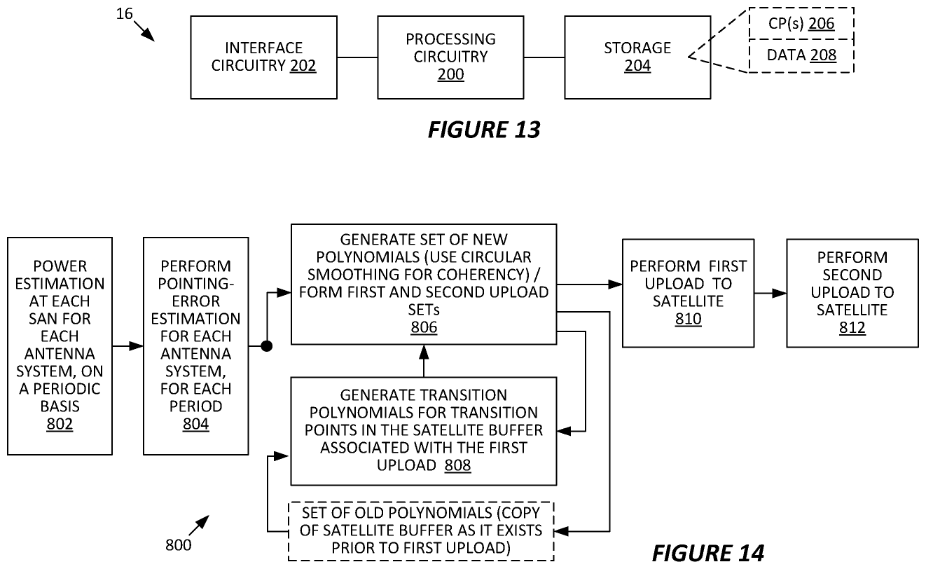

FIG. 13 illustrates an example ground node 16 that includes processing circuitry 200, interface circuitry 202, and storage 204. The processing circuitry 200 comprises fixed circuitry or programmatically configured circuitry or a mix of both. Because the ground node 16 is communicatively coupled within the ground segment 12 to the SANs 32 or to one or more other nodes that are in communication with the SANs 32, the ground node 16 may also be referred to as a network node 16.

In at least one embodiment, the processing circuitry 200 of the ground node 16 comprises one or more microprocessors, Digital Signal Processors (DSPs), Application Specific Integrated Circuits (ASICs), Field Programmable Gate Arrays (FPGA), or a mix thereof. In particular, the processing circuitry 200 may comprise a microprocessor or other digital processing logic that is specially adapted to perform all or one or more operations comprising the update process described herein, based on the execution of stored computer program instructions, which may be comprised in one or more computer programs (“CPs”) 206 held in the storage 204. In such embodiments, the storage 204 comprises one or more types of computer-readable media, such as volatile memory for working storage of program instructions and scratch data associated with program execution, along with non-volatile memory for longer-term storage of program instructions and one or more items of configuration data 208. The configuration data 208 comprises, for example, information about the SCS 10 for use in performing operations in support of the update process.

In particular, with reference to FIG. 8, the processing circuitry 200 may be configured as the pointing error estimation circuitry 24 or the pointing error compensation circuitry 26 or both. In this context, the interface circuitry 202 at least comprises, for example, physical-layer circuitry for wired or wireless coupling to the SANs 32 in the SAN farm 30, or for communicatively coupling to another ground node 16 in the ground segment 12, as an intermediate node that in turn communicates with the SANs 32. As a non-limiting example, the interface circuitry 202 comprises an Ethernet interface or other computer-network interface. FIG. 14 illustrates a method 800 representing an example embodiment of the update process described herein. Operations include estimating (Block 802) received power at each SAN 32 with respect to each satellite antenna system being evaluated for pointing error. These power measurements are made, for example, during each minute of each sub-interval of a measurement interval, with pointing error (Block 804) estimated from each such measurement. In this context, the power received at each SAN 32 from the satellite antenna system under evaluation depends on the location of the SAN 32 and the alignment of the satellite antenna system, meaning that the power measurements across the SAN farm 30 exhibit a characteristic pattern or mapping, as a function of the pointing direction of the antenna and thus provide a basis for estimating pointing error.

At the end of the measurement interval, the SCS 10 generates (Block 806) a set of new polynomials for the satellite 50 to apply in the satellite 50 for the involved antenna system during a next measurement interval. Processing also includes generating (Block 808) one or more transitional polynomials for transition points that will exist in the satellite buffer after completion of the first upload. Processing continues with performing (Block 810) the first upload to the satellite 50, with the first upload transferring a hybrid or mixed set of polynomials as previously described. Further, the method 800 includes performing (Block 812) a second upload to replace the transitional polynomial(s) contained in the buffer with corresponding ones of the new polynomials. More generally, the second upload can be understood as leaving the buffer in the satellite filled with the complete set of new polynomials. Thus, if the first upload was configured such that one or more old polynomials remained in the buffer after completion of the first upload, the second upload replaces any such old polynomials with corresponding new polynomials. Two polynomials are “corresponding” in the sense that they belong to the same buffer position/sub-interval index.

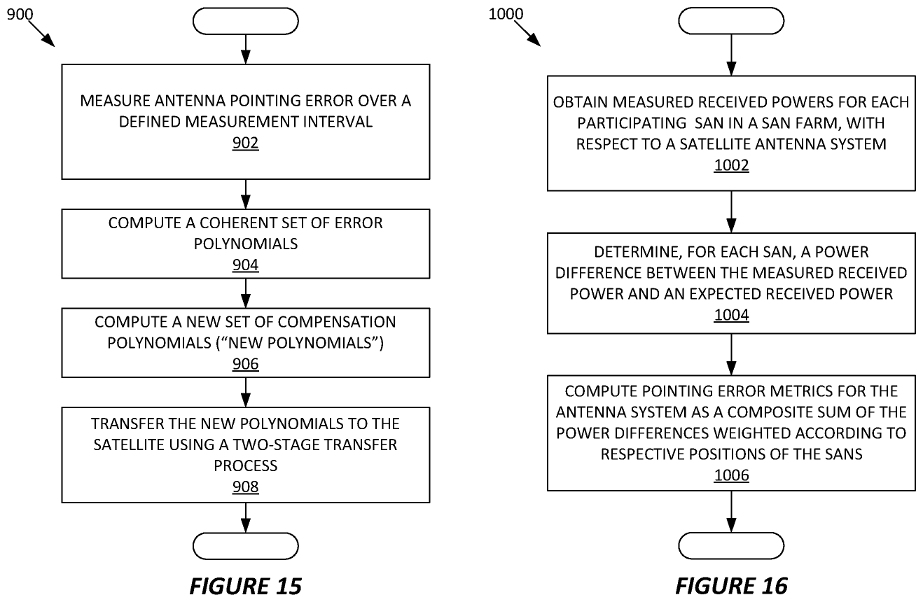

FIG. 15 depicts a method 900 that encompasses aspects of the overall operations depicted in FIG. 14 and may be performed by one or more ground nodes 16 of the SCS 10, to compensate for an antenna pointing error of the satellite 50. The method 900 comprises: (a) measuring (Block 902) antenna pointing errors of the satellite 50 over a measurement interval in which the satellite 50 applies the set of polynomials currently held in its buffer; (b) computing (Blocks 904 and 906) a coherent set of error polynomials from the pointing-error measurements and using the error polynomials to compute a set of new compensation polynomials (“new polynomials”) to be applied by the satellite in a next measurement interval; and (d) transferring (Block 908) the new polynomials to the satellite 50 using a two-stage transfer process, such as exemplified in FIGS. 2 and 4-7.

The method 900 may be repeated by a ground node 16 on an ongoing basis, and may be carried out with respect to each of two or more antenna systems 56 onboard the satellite.

Computing the set of new polynomials is a three-step process in one or more embodiments. That process comprises: (i) computing temporary overlapping error polynomials corresponding to each sub-interval of the measurement interval, where measurement data for each overlapping polynomial extends into the preceding and succeeding sub-intervals of the measurement interval; (ii) computing a coherent set of error polynomials for the measurement interval from the pointing-error measurements, based on the temporary overlapping polynomials and corresponding boundary values demarking the hourly boundaries, to ensure coherency of the error polynomials; and (iii) subtracting the resulting error polynomials from the set of old polynomials currently in the buffer of the satellite, to yield the new polynomials.

Here, it will be understood that the ground segment retains of copy of those old polynomials for such purposes. Further, it will be understood that computing the new polynomials based on the pointing-error measurements made for the most recent measurement interval means computing the new polynomials from pointing-error metrics described below.

Performing the first and second uploads included in the method 900 comprises, for example, transmitting respective first and second signaling on an uplink control channel used to communicate control signaling from the ground segment 12 to the satellite 50.

In one or more embodiments, the antenna pointing error is an error of a steerable antenna reflector onboard the satellite 50, and each old or new polynomial is a respective pair of polynomials computed for derivation of azimuthal and elevational steering adjustments of the steerable antenna reflector, during a corresponding one of the sub-intervals defined by the satellite buffer. For example, with reference to the first antenna system 56-1, which serves the SANs 32, pointing error compensation onboard the satellite 50 comprises the pointing error compensation control circuitry 62 generating Az/El control commands for an antenna control system that is included in the bus 52 of the satellite 50 and is configured to actuate one or more gimbals or other positioning mechanisms included in the reflector mount 82, to control the Az/El angles of the reflector 80. For the second antenna system 56-2, which serves UTs 72, the same approach may be used separately to control the reflector mount 102, for adjusting the Az/El angles of the reflector 100. That is, the method 800 and any related or extending methods may be applied separately to each of two or more antenna systems onboard the satellite 50, provided that they allow for independent steering.

An example ground node 16 comprises processing circuitry 200 and interface circuitry 202. The processing circuitry 200 is configured to perform the method 900, which may include the processing circuitry 200 using the interface circuitry 202 to send and receive signaling, e.g., for obtaining power-measurement information regarding the SANs 32, initiating uploads to the satellite 50, etc. In at least one example, the storage 204 in the ground node 16 stores one or more computer programs comprising computer program instructions that, when executed by one or more microprocessors of the node, configure the one or more microprocessors to carry out the method 900. In this regard, the programmatically configured microprocessor(s) can be understood as an example embodiment of the processing circuitry 200.

FIG. 16 illustrates another method 1000 of operation, which may be performed by the same one or more ground nodes 16 that are configured to perform the method 900 or may be performed by one or more ground nodes 16 that are separate from the node(s) that implement the method 900. The method 1000 comprises: (a) obtaining (Block 1002) measured received powers with respect to SANs 32 in a SAN farm 30 comprising a plurality of geographically distributed SANs 32, the measured received power for each SAN 32 determined with respect to an antenna system 56 onboard a satellite 50 of the satellite communications system, and being dependent upon an actual pointing direction of the antenna system 56 and a position of the SAN 32 within the SAN farm 30; (b) determining (Block 1004), for each SAN 32, a power difference between the measured received power and an expected received power corresponding to a nominal pointing direction of the antenna system 56; and (c) computing (Block 1006) pointing error metrics for the antenna system 56 as a composite sum of the power differences weighted according to the respective positions of the SANs 32.

Here, use of the reference number “56” without suffixing serves as a general reference to either the antenna system 56-1 or the antenna system 56-2. Of course, the method 1000 and the other methods disclosed herein are not limited to the specific implementation details shown for the antenna systems 56-1 and 56-2.

Obtaining the measured received powers comprises, for example, receiving the measured received powers from the respective SANs 32 in the SAN farm 30 or from an intermediate ground node 16 in the ground segment 12. The measured received power for each SAN 32 is based, for example, on each SAN 32 performing a first received power measurement during a measurement window wherein the power amplifiers of the involved transponders of the antenna system 56 operate in a saturated mode for noise transmission, and performing a second received power measurement during a corresponding quiet window wherein the antenna system 56 does not transmit, with the measured received power for the SAN 32 then determined by adjusting the first received power measurement based on the second received power measurement. This adjusting step may be performed in the respective SANs 32 or by the ground node(s) 16 carrying out the method 1000.

The measurement window and the corresponding quiet window are periodically reoccurring window pairs within any given measurement interval, and the method 1000 includes computing the pointing error metrics for each of the periodically recurring window pairs, based on the power differences determined in each of the periodically recurring window pairs. For example, the measurement and quiet windows occur during each minute of each sub-interval of a measurement interval.

In an example scenario, the antenna system 56 communicatively couples the satellite 50 with UTs 72 in a satellite service area 74 and comprises a plurality of transmit antenna feeds 96 providing a corresponding plurality of component beams used for beamformed illumination of the satellite service area 74. In at least one embodiment, the satellite service area 74 subsumes the area 34 of the SAN farm 30. For example, the satellite service area 74 is the continental United States and the SAN farm 30 is located therein. In an embodiment corresponding to such geographic arrangements, the method 1000 comprises, for each measurement window, deactivating transmit antenna feeds 96 that have component beam footprints that fall within the area of the SAN farm 30. Correspondingly, for each measurement window, the method 1000 includes or otherwise depends on operating activated ones of the transmit antenna feeds 96 at a high gain, with at least some of the SANs 32 in the SAN farm 30 transmitting pseudo-noise uplink signals, for driving transmit power amplifiers 92 of the activated transmit antenna feeds 96 into saturation.

In another example scenario, the antenna system 56 communicatively couples the satellite 50 with the SANs 32 and comprises a plurality of transmit antenna feeds 122 providing a corresponding plurality of component beams used for illumination of the SAN farm 30. Correspondingly, the method 1000 includes or otherwise depends on, for each measurement window, driving transmit power amplifiers 118 of the transmit antenna feeds 122 into saturation.

The method 1000 in one or more embodiments further includes calculating a set of new polynomials for use by the satellite in compensating for antenna-pointing error over a next measurement interval. The new polynomials are based on the computed pointing error metrics obtained using the pointing-error measurements collected over the most recent measurement interval. Thus, the method 1000 may be extended to include the polynomial computation and two-stage transfer (uploading) operations shown in the method 900 and further described elsewhere herein. A same ground node 16 may perform this extended method, or more than one ground node 16 may cooperate to perform the extended method.

The expected received power at each SAN in the SAN farm is based on characterized downlink radiation patterns of the antenna system 56, with respect to the position of the SAN 32 within the SAN farm, and wherein the measured received power at each SAN 32 depends on actual downlink radiation patterns of the antenna system. Detailed characterization and manufacturing data known for the antenna system(s) 56 onboard the satellite, along with SAN positions, etc., may be used to compute expected received powers.

The nominal pointing direction of the antenna system 56 may be defined as the boresight of the antenna system 56 pointing at a defined target location—e.g., a specific geographic location within the SAN farm area 34 or within the larger satellite service area 74. Correspondingly, the pointing error metric expresses a pointing error of the antenna system 56 as angular deviations from azimuthal and elevational angles corresponding to the defined target location.

In one or more embodiments, for determining the power differences, the measured received powers are normalized to account for differences in reception gain between different SANs 32, and, further, both the measured received powers and the expected received powers are normalized against corresponding total powers. For example,
r[m] is the measured received power at the m-th one of M SANs comprised in the SAN farm, before normalization;
r*[m] is the expected received power at the m-th one of M SANs comprised in the SAN farm, before normalization;
R[m] is the measured received power at the m-th one of M SANs comprised in the SAN farm, after normalization;
R*[m] is the expected received power at the m-th one of M SANs comprised in the SAN farm, after normalization;
Az[m] is the azimuthal position of the m-th SAN within a range of azimuthal values spanned by the SAN farm;
El[m] is the elevational position of the m-th SAN within a range of elevational values spanned by the SAN farm; and
the pointing error metrics are computed as azimuthal error metric Mₓ and an elevational error metric M_{y}, with:

$${M}_{x} = {\sum }_{m = 1}^{M} ( R [ m ] - {R}^{*} [ m ] ) A z [ m ] , and \\ {M}_{y} = {\sum }_{m = 1}^{M} ( R [ m ] - {R}^{*} [ m ] ) E l [ m ] .$$

As with the method 900, one or more ground nodes 16 of the SCS 10 may be configured to carry out any or all operations included in the method 1000. See FIG. 13 for example details of such a ground node 16.

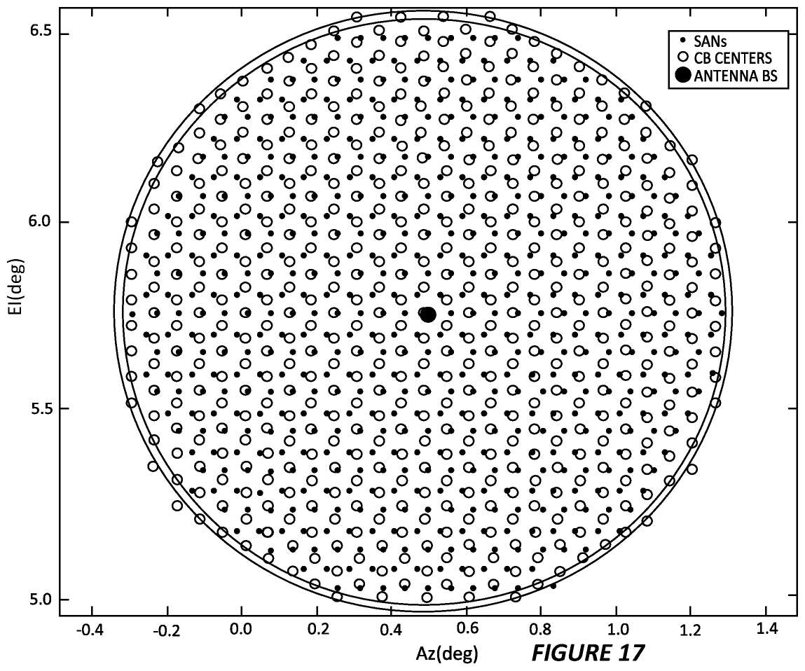

FIGS. 17-20 relate to the antenna system 56-1, which serves the SANs 32 in the SAN farm 30 and may be referred to as a feeder-link antenna system.

FIG. 17 is a plot or plan view of an example SAN farm 30, including a geographically distributed set of SANs 32. The plot also depicts the component beam (CB) centers of the CBs output by the plurality of transmit antenna feeds 122 of the first antenna system 56-1. Here, it will be understood that each transmit antenna feed 122 produces a respective one of the CBs, with the positioning of the feed 122 relative to the reflector 80 and the angle of the reflector 80 determining where the respective CB falls on the surface of the Earth.

FIG. 17 also depicts the boresight (BS) of the first antenna system 56-1 in a nominal case. That is, FIG. 17 can be understood as depicting the CB centers for a correct pointing of the first antenna system 56-1. For example, the nominal pointing direction centers the BS of the antenna system 56-1 at the center of mass for the SAN farm 30, which, with the depicted arrangement is at {0.5, 5.75} in terms of Az and El values. In this nominal case, the pointing error (PE) for Az equals zero and the PE for El equals zero.

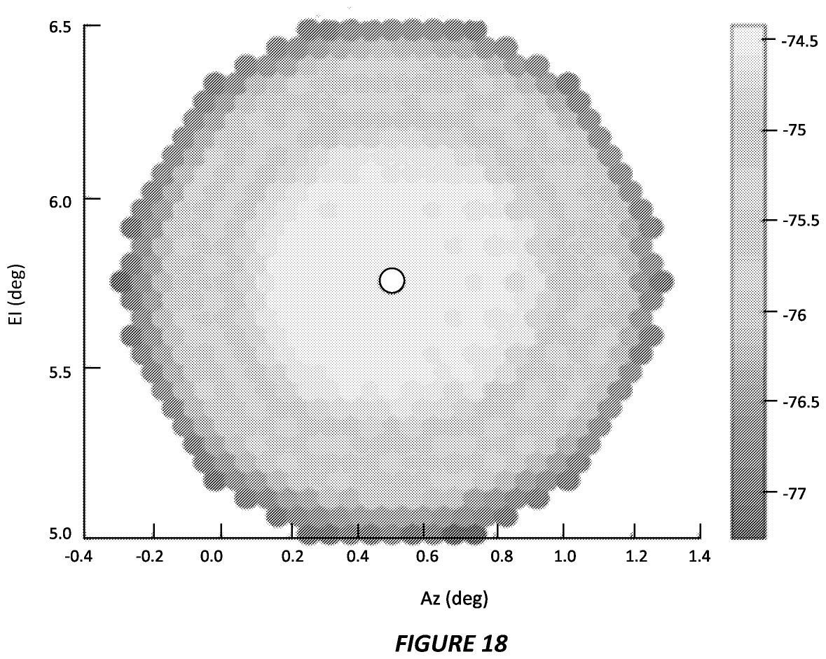

FIG. 18 corresponds directly with FIG. 17, and it illustrates an expected power distribution map across the SANs 32 of the SAN farm 30, for the correct pointing of the first antenna system 56-1. Particularly, FIG. 18 depicts the expected received noise power in dBm, with the power amplifiers 118 of the transmit antenna feeds 122 driven into saturation, with no input signal to the associated transponders 60. Saturated-mode operation of the power amplifiers 118 means that they all reliably output roughly the same power.

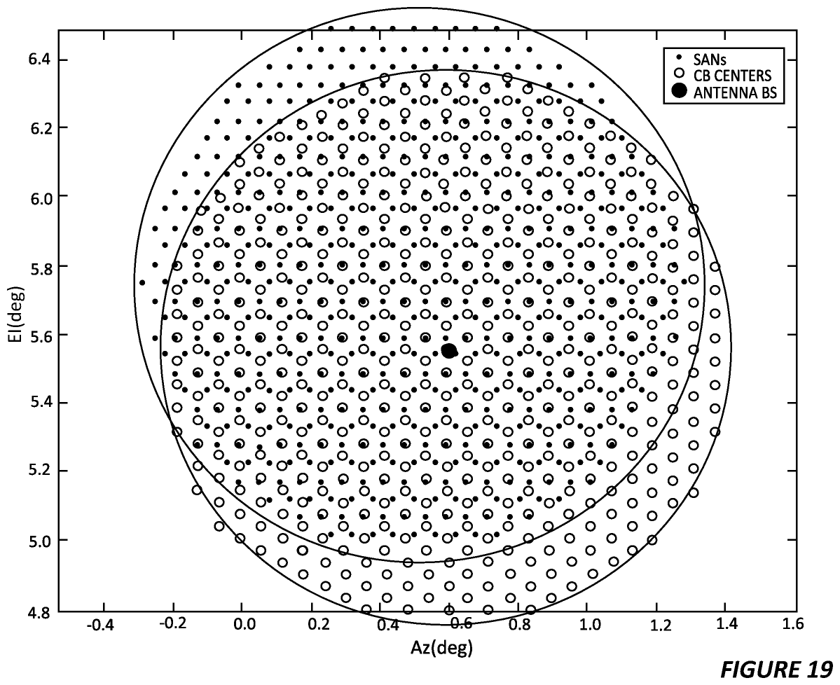

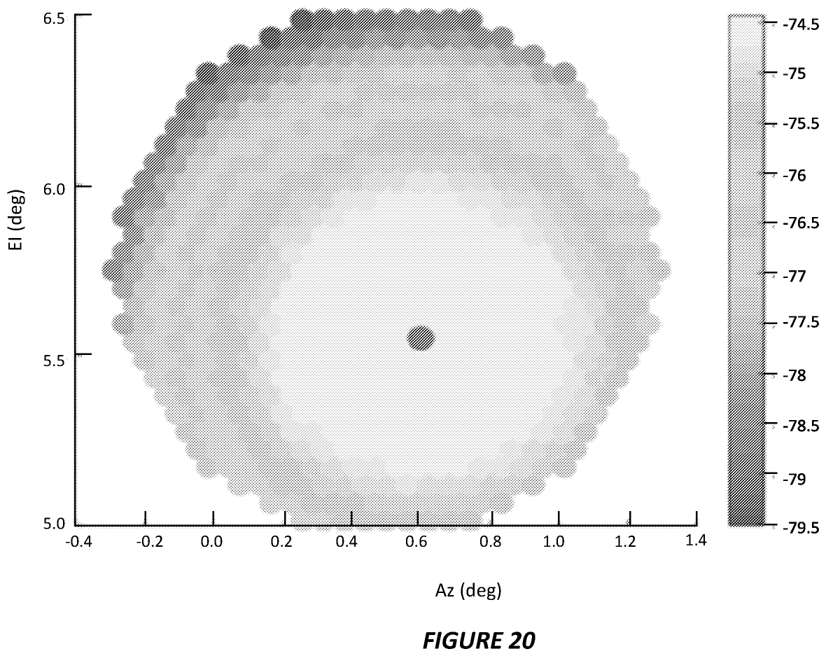

The expected power distribution map, e.g., the expected received power at each SAN 32, for this nominal pointing case may be stored in the one or more ground nodes 16, for use in determining pointing error. FIG. 19 depicts an example error scenario, where the antenna BS has shifted by 0.1 degree Az and −0.2 degrees El. Thus, the antenna BS now has a location corresponding to {0.6, 5.55}. As seen, the CB centers shift correspondingly. FIG. 20 illustrates a measured power distribution map for the SAN farm 32 corresponding to the misalignment seen in FIG. 19. Comparing the expected received powers shown in FIG. 18 with the measured received powers shown in FIG. 20 provides the basis for determining the pointing error.

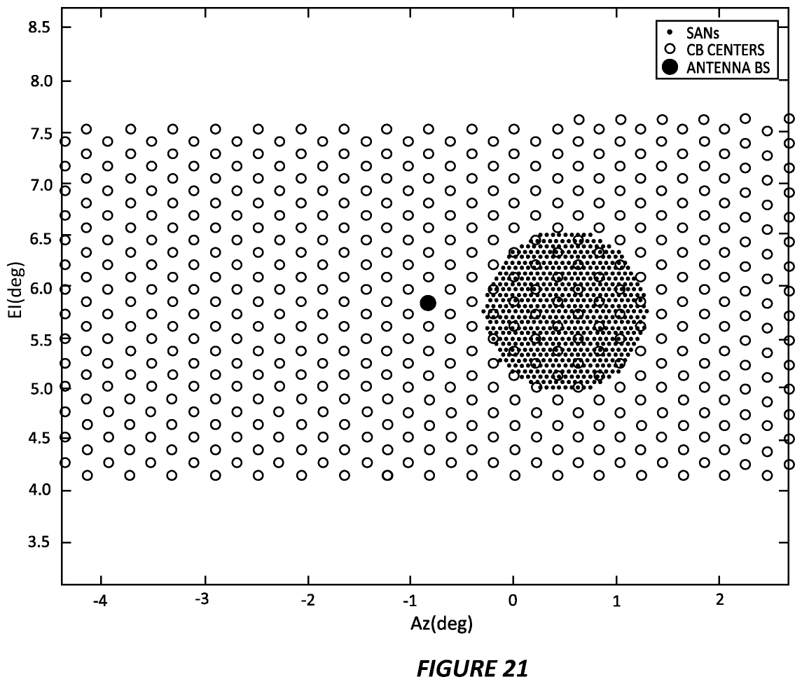

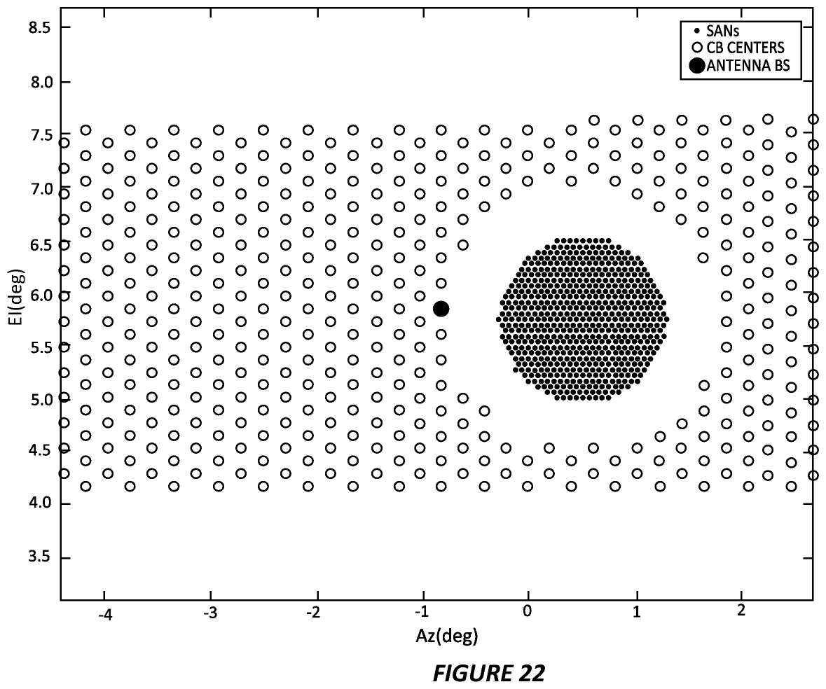

FIGS. 21-22 relate to the antenna system 56-2, which serves the UTs 72 in the satellite service area 74.

FIG. 21 illustrates the geographic locations of the CB centers of the CBs output by the plurality of transmit antenna feeds 96 of the second antenna system 56-2, for the nominal or correct pointing direction of the antenna system 56-2. For example, the nominal pointing direction places the antenna BS at center of the continental United States, in the example where the continental United States is the satellite service area 74. For example, there are 512 transmit antenna feeds 96 of the second antenna system 56-2, producing 512 CBs having CB centers evenly distributed over the satellite service area 74 for serving UTs 72. The SAN farm 30 may be located in the eastern continental United States. Thus, the SANs 32 occupy a region within the satellite service area 74, although the SANs 32 may operate with different signal frequencies and/or polarizations as compared to UTs 72, to avoid interference between the feeder links and the user links.

Using the SANs 32 to estimate the pointing error of the second antenna system 56-2 involves deactivating a subset of the transmit antenna feeds 96 of the second antenna system 56-2. Specifically, the transponders 58 associated with the transmit antenna feeds 96 that output CBs having CB centers falling within the area 34 of the SAN farm 30 are deactivated. The power amplifiers 92 of the remaining, activated transponders 58 are assumed to operate in saturated mode and transmit noise. In one embodiment, transponders 58 that radiate within the sqrt (1.5) degree radius from the center of the SAN farm 32 are turned off when estimating pointing error for the second antenna system 56-2. In the context of the figures, that would mean that the expected and measured received powers are based on having 413 transponders 58 active rather than 512 transponders 58 active. Note that one or more SANs 32 may transmit uplink noise during the measurement windows in which the SANs 32 measure received power with respect to the antenna system 56-2 for pointing error estimation, to facilitate driving the power amplifiers 92 of the activated transponders 58 into saturated-mode operation.

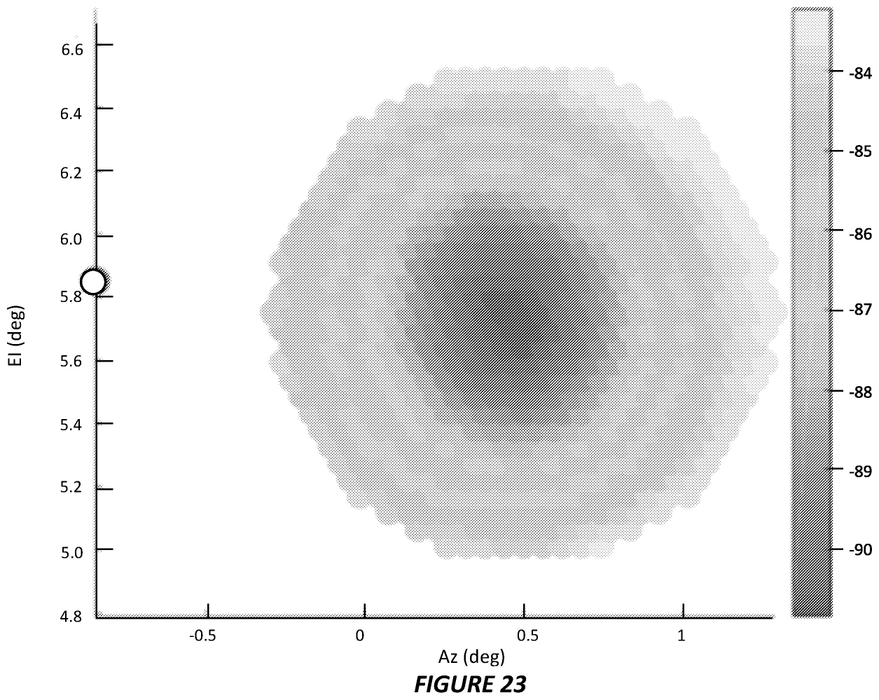

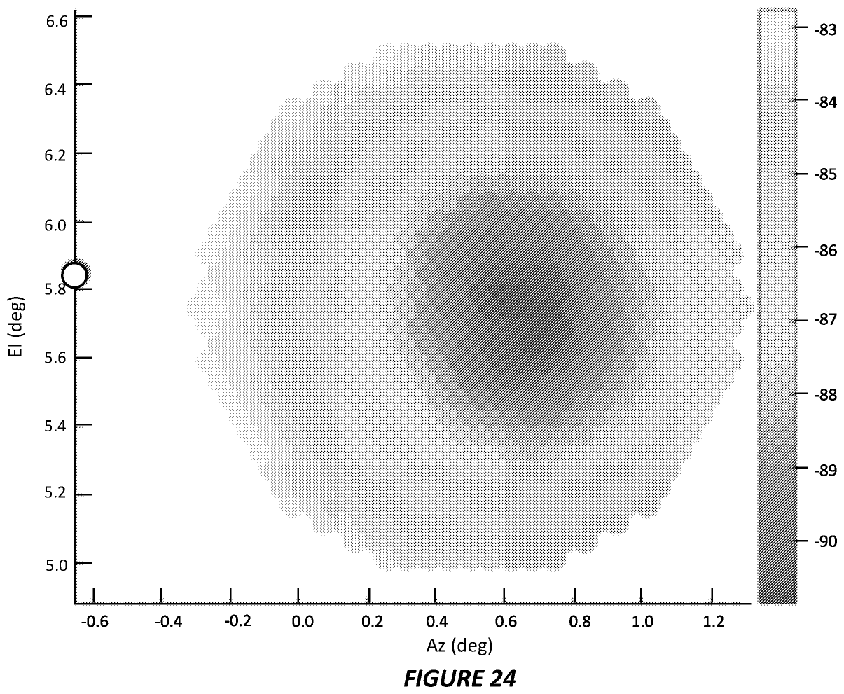

FIG. 22 illustrates the “missing” CB centers corresponding to the deactivated transponders 58. FIG. 23 illustrates the expected received power distribution map for nominal pointing case for the second antenna system 56-2, and FIG. 24 illustrates the measured received power distribution map assuming an offset of the antenna BS from its nominal location.

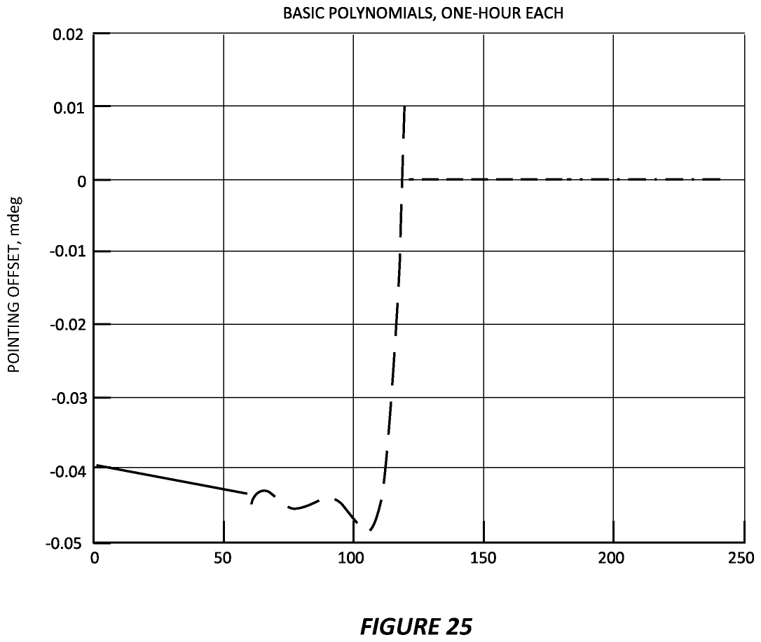

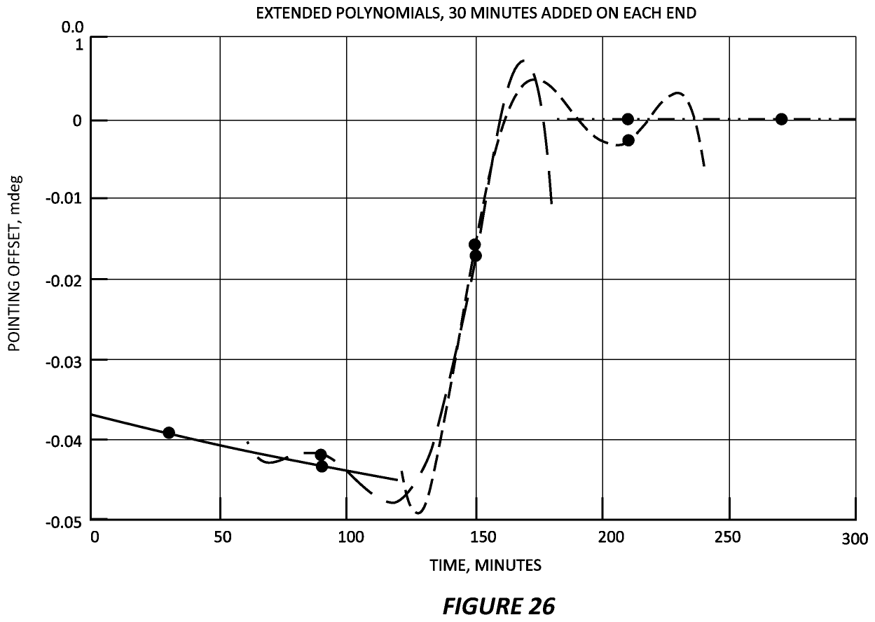

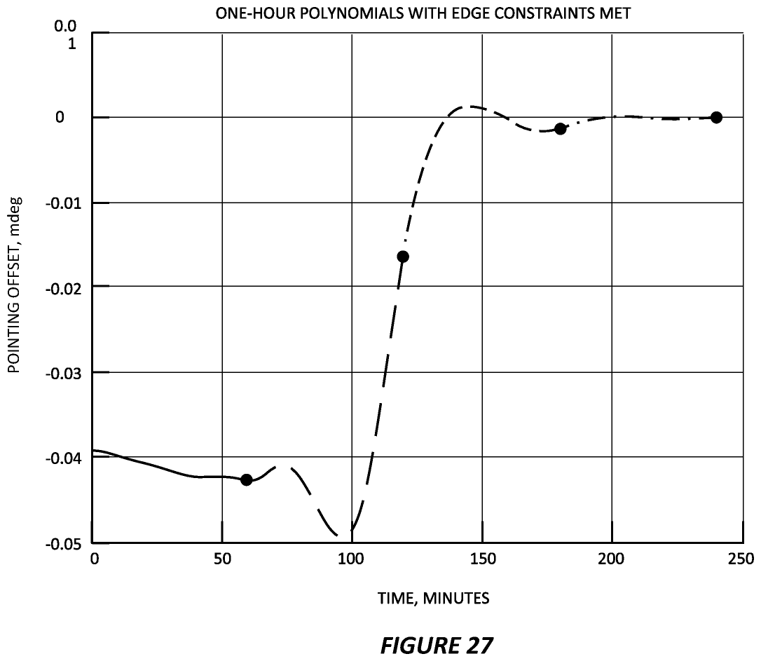

FIG. 25 illustrates a basic one-hour polynomial, such as might correspond to an ephemeris update, and with the antenna pointing error expressed in milli-degrees (“mdeg”). FIG. 26 illustrates one approach to extending the one-hour polynomial by adding thirty minutes to each end, and FIG. 27 illustrates the corresponding one-hour version with edge constraints met. These polynomial examples correspond to use of hours as the sub-intervals defined by the satellite buffer. However, it should be understood that other sub-interval lengths may be used. Broadly, the polynomials are computed for the particular length of sub-interval used in the satellite. Similarly, the buffer cycle is a multiple of a base physical cycle of twenty-four-hours and thus may be twenty-four-hours long, forty-eight-hours long, etc.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-56. (canceled)

57. A method of updating a set of polynomials held in a buffer of a satellite, each polynomial held in a respective one among a plurality of ordered buffer positions collectively representing a buffer cycle that is an integer multiple of a base twenty-four cycle, the buffer cycle subdivided into an integer number of sub-intervals, with each buffer position corresponding to a respective one of the sub-intervals and the satellite configured to apply the set of polynomials in sequence over each buffer cycle, for compensating a pointing error of an antenna system onboard the satellite, the method comprising:
computing a set of new polynomials from pointing-error measurements made over a most recently completed measurement interval, which is defined as a contiguous span of sub-intervals equal in length to the buffer cycle and for which coherent pointing-error measurements are available, and wherein in relation the set of polynomials in the buffer of the satellite are considered old polynomials; and
transferring the new polynomials to the satellite for replacement of the old polynomials using a two-stage transfer process that includes a first upload and a subsequent second upload and comprising:
performing the first upload in one or more consecutive sub-intervals defining an upload management window, the first upload defining a first transition window that immediately follows the upload management window in linear time and a second transition window that follows the first transition window in linear time, with the first upload containing one or more first transitional polynomials for loading into the one or more buffer positions corresponding to the first transition window, one or more second transitional polynomials for loading into the one or more buffer positions corresponding to the second transition window, and new polynomials for loading into the buffer positions corresponding to the sub-intervals between the first and second transition windows, with respect to linear time; and
performing the second upload after successful completion of the first upload, the second upload completing the replacement of new polynomials for all buffer positions.

58. The method according to claim 57, wherein, with respect to each buffer position, the satellite reads the contents of the buffer position at the beginning of the corresponding sub-interval, such that changes made to the contents of the buffer position are not read until the next read of the buffer position in the next repetition of the buffer cycle.

59. The method according to claim 58, wherein the one or more first transitional polynomials are calculated to smooth a transition from use by the satellite of the polynomial read by the satellite at the beginning of the last sub-interval contained in the upload management window to use by the satellite of the polynomial that will be read by the satellite at the beginning of the first sub-interval following the first transition window.

60. The method according to claim 58, wherein the one or more second transitional polynomials are calculated to smooth a transition from use by the satellite of the polynomial that will be read by the satellite at the beginning of the last sub-interval before the second transition window to use by the satellite of the polynomial that will be read by the satellite at the beginning of the first sub-interval following the second transition window.

61. The method according to claim 57, wherein, with respect to each buffer position, the satellite reads the contents of the buffer position repeatedly during the corresponding sub-interval.

62. The method according to claim 61, wherein the one or more first transitional polynomials are calculated to smooth the transition from the polynomial used in the sub-interval that immediately precedes the beginning of the first transition window, to the polynomial that is used in the sub-interval that immediately follows the end of the first transition window.

63. The method according to claim 61, wherein the one or more second polynomials are calculated to smooth the transition from the polynomial that is used in the sub-interval that immediately precedes the beginning of the second transition window, to the polynomial that is used in the sub-interval that immediately follows the end of the second transition window.

64. The method according to claim 57, wherein the set of old polynomials and the set of new polynomials are respective coherent sets, and wherein the method comprises providing coherency in each set by computing each polynomial in the set using partially overlapping measurement times and by smoothing a last one of the polynomials in the set for wraparound transitioning into a first one of the polynomials in the set, for cyclic application of the set by the satellite.

65. The method according to claim 57, wherein the method comprises computing the set of new polynomials in a three-step process that comprises:
computing temporary overlapping error polynomials for each sub-interval of the most recently completed measurement interval, where the pointing-error measurements used for determining each overlapping error polynomial extends into the preceding and succeeding sub-intervals within the most recently completed measurement interval;
computing a coherent set of error polynomials for the most recently completed measurement interval from the pointing-error measurements, based on the temporary overlapping polynomials and corresponding boundary values demarking the sub-interval boundaries, to ensure coherency of the error polynomials; and
subtracting the coherent set of error polynomials from the old polynomials to yield the set of new polynomials.

66. The method according to claim 57, wherein performing the first and second uploads comprises transmitting respective first and second signaling on an uplink control channel used to communicate control signaling from a ground segment to the satellite.

67. The method according to claim 57, wherein the pointing error is an error of a steerable antenna reflector of the antenna system, and wherein each of the old and new polynomials is computed for derivation of azimuthal and elevational steering adjustments of the steerable antenna reflector during the corresponding sub-interval.

68. The method according to claim 67, wherein the antenna system serves user terminals of a satellite communications system that includes the satellite.

69. The method according to claim 67, wherein the antenna system serves a Satellite Access Node (SAN) farm of a satellite communications system that includes the satellite.

70. The method according to claim 57, further comprising carrying out the method with respect to each one of two or more antenna systems onboard the satellite.

71. A ground node in a ground segment of a satellite communications, the ground node comprising:
interface circuitry; and
processing circuitry that is configured to update a set of polynomials held in a buffer of a satellite of the satellite communications system, each polynomial held in a respective one among a plurality of ordered buffer positions collectively representing a buffer cycle that is an integer multiple of a base twenty-four cycle, the buffer cycle subdivided into an integer number of sub-intervals, with each buffer position corresponding to a respective one of the sub-intervals and the satellite configured to apply the set of polynomials in sequence over each buffer cycle, for compensating a pointing error of an antenna system onboard the satellite, wherein, to carry out the update, the processing circuitry is configured to:
compute a set of new polynomials from pointing-error measurements made over a most recently completed measurement interval, which is defined as a contiguous span of sub-intervals equal in length to the buffer cycle and for which coherent pointing-error measurements are available, and wherein in relation the set of polynomials in the buffer of the satellite are considered old polynomials; and
transfer the new polynomials to the satellite for replacement of the old polynomials using a two-stage transfer process that includes a first upload and a subsequent second upload and for which the processing circuitry is configured to:
perform the first upload in one or more consecutive sub-intervals defining an upload management window, the first upload defining a first transition window that immediately follows the upload management window in linear time and a second transition window that follows the first transition window in linear time, with the first upload containing one or more first transitional polynomials for loading into the one or more buffer positions corresponding to the first transition window, one or more second transitional polynomials for loading into the one or more buffer positions corresponding to the second transition window, and new polynomials for loading into the buffer positions corresponding to the sub-intervals between the first and second transition windows, with respect to linear time; and
perform the second upload after successful completion of the first upload, the second upload completing the replacement of new polynomials for all buffer positions.

72. The ground node according to claim 71, wherein, with respect to each buffer position, the satellite reads the contents of the buffer position at the beginning of the corresponding sub-interval, such that changes made to the contents of the buffer position are not read until the next read of the buffer position in the next repetition of the buffer cycle.

73. The ground node according to claim 72, wherein the one or more first transitional polynomials are calculated to smooth a transition from use by the satellite of the polynomial read by the satellite at the beginning of the last sub-interval contained in the upload management window to use by the satellite of the polynomial that will be read by the satellite at the beginning of the first sub-interval following the first transition window.

74. The ground node according to claim 72, wherein the one or more second transitional polynomials are calculated to smooth a transition from use by the satellite of the polynomial that will be read by the satellite at the beginning of the last sub-interval before the second transition window to use by the satellite of the polynomial that will be read by the satellite at the beginning of the first sub-interval following the second transition window.

75. The ground node according to claim 71, wherein, with respect to each buffer position, the satellite reads the contents of the buffer position repeatedly during the corresponding sub-interval.

76. The ground node according to claim 75, wherein the one or more first transitional polynomials are calculated to smooth the transition from the polynomial that is used in the sub-interval that immediately precedes the beginning of the first transition window, to the polynomial that is used in the sub-interval that immediately follows the end of the first transition window.

77. The ground node according to claim 75, wherein the one or more second polynomials are calculated to smooth the transition from the polynomial that is used in the sub-interval that immediately precedes the start of the second transition window, to the polynomial that is used in the sub-interval that immediately follows the end of the second transition window.

78. The ground node according to claim 71, wherein the set of old polynomials and the set of new polynomials are respective coherent sets, and wherein the processing circuitry is configured to provide coherency in each set by computing each polynomial in the set using partially overlapping measurement times and by smoothing a last one of the polynomials in the set for wraparound transitioning into a first one of the polynomials in the set, for cyclic application of the set by the satellite.

79. The ground node according to claim 71, wherein the set of new polynomials is computed in a three-step process, for which the processing circuitry is configured to:
compute temporary overlapping error polynomials for each sub-interval of the most recently completed measurement interval, where the pointing-error measurements used for determining each overlapping error polynomial extends into the preceding and succeeding sub-intervals within the most recently completed measurement interval;
compute a coherent set of error polynomials for the most recently completed measurement interval from the pointing-error measurements, based on the temporary overlapping polynomials and corresponding boundary values demarking the sub-interval boundaries, to ensure coherency of the error polynomials; and
subtract the coherent set of error polynomials from the old polynomials to yield the new polynomials.

80. The ground node according to claim 71, wherein, for performing the first and second uploads, the processing circuitry is configured to transmit respective first and second signaling on an uplink control channel used to communicate control signaling from the ground segment to the satellite.

81. The ground node according to claim 71, wherein the pointing error is an error of a steerable antenna reflector of the antenna system, and wherein each of the old and new polynomials is computed for derivation of azimuthal and elevational steering adjustments of the steerable antenna reflector during the corresponding sub-interval.

82. The ground node according to claim 81, wherein the antenna system serves user terminals of a satellite communications system that includes the satellite.

83. The ground node according to claim 81, wherein the antenna system serves a Satellite Access Node (SAN) farm of a satellite communications system that includes the satellite.

84. The ground node according to claim 71, wherein the processing circuitry is configured to carry compute and transfer polynomials to the satellite for each one of two or more antenna systems onboard the satellite.
